(19) United States
(12) Patent Application Publication
(10) Pub. No.: US 2024/0333125 A1
(43) Pub. Date: Oct. 3, 2024

(54) SWITCH-MODE POWER CONVERTERS WITH PEAK VALUE DETERMINATION FOR MAGNETIZATION CURRENTS IN DISCONTINUOUS CONDUCTION MODE AND METHODS THEREOF

(71) Applicant: ON-BRIGHT ELECTRONICS (SHANGHAI) CO., LTD., Shanghai (CN)

(72) Inventors: TUOFU LIU, Shanghai (CN); QIAN FANG, Shanghai (CN); YUN SUN, Shanghai (CN); XIUHONG ZHANG, Shanghai (CN)

(21) Appl. No.: 18/623,531

(22) Filed: Apr. 1, 2024

(30) Foreign Application Priority Data
Mar. 31, 2023 (CN) 202310341749.1

(51) Int. Cl. H02M 1/00; H02M 1/32; H02M 3/335

(52) U.S. Cl. CPC H02M 1/0009; H02M 1/32; H02M 3/33507; H02M 3/33571

(57) ABSTRACT

Controller and method for a power converter. For example, a controller for a power converter includes: an output-voltage detector configured to detect a value of an output voltage of the power converter and generate a detection signal that represents the detected value of the output voltage; and a peak-current-value determination unit configured to receive the detection signal and determine a peak value of a magnetization current for the power converter in a discontinuous conduction mode; wherein the peak-current-value determination unit is further configured to: determine the peak value of the magnetization current for the power converter in the discontinuous conduction mode based on at least information associated with the detected value of the output voltage of the power converter; and generate a peak signal that represents the determined peak value of the magnetization current.

### 1. CROSS-REFERENCES TO RELATED APPLICATIONS

This application claims priority to Chinese Patent Application No. 202310341749.1, filed Mar. 31, 2023, incorporated by reference herein for all purposes.

### 2. FIELD OF THE DISCLOSURE

Certain embodiments of the present disclosure are directed to circuits. More particularly, some embodiments of the disclosure provide peak value determination for magnetization currents. Merely by way of example, some embodiments of the disclosure have been applied to asymmetrical half-bridge flyback switch-mode power converters in discontinuous conduction mode. But it would be recognized that the disclosure has a much broader range of applicability.

### 3. BACKGROUND OF THE DISCLOSURE

With the development of consumer electronics, the demand for portable chargers, especially high-power miniaturized chargers with large power density, have increased significantly. Many conventional chargers, such as flyback power supplies, often have large size and low power efficiency. In contrast, conventional chargers that use half-bridge resonant circuit (LLC) often have high power efficiency and high power density, but these conventional chargers usually are costly to make and often do not work well with a wide range of output voltage. For medium and high power levels, asymmetrical half-bridge flyback switch-mode power converters usually can improve power efficiency, reduce charger size, raise power density, and/or reduce charger cost.

FIG. 1 is a simplified diagram showing certain components of a conventional asymmetrical half-bridge flyback switch-mode power converter. The asymmetrical half-bridge flyback switch-mode power converter 100 includes a control unit 110, a switch unit 120, a resonance unit 130, a transformer unit 140, a rectifying unit 150, an output unit 160, and a feedback unit 170.

The switch unit 120 receives an input voltage 101 (e.g., Vᵢₙ) and also receives one or more control signals 111 from the control unit 110. For example, the input voltage 101 (e.g., Vᵢₙ) is a DC voltage. Additionally, the switch unit 120 includes one or more switches. In response to the one or more control signals 111, the one or more switches of the switch unit 120 are opened and/or closed, and the switch unit 120 generates a voltage 121 based at least in part on the input voltage 101 (e.g., Vᵢₙ). The voltage 121 is received by the resonance unit 130, which processes the voltage 121. The resonance unit 130 is directly or indirectly connected to the transformer unit 140, which directly or indirectly outputs a signal 141 to the control unit 110. Additionally, the transformer unit 140 is connected to the rectifying unit 150. The rectifying unit 150 outputs a rectified voltage and/or a rectified current to the output unit 160. In response, the output unit 160 generates an output voltage and/or an output current. Additionally, the output unit 160 is connected to the feedback unit 170, which provides a feedback signal 171 to the control unit 110. Based at least in part on the signal 141 and/or the feedback signal 171, the control unit 110 generates the one or more control signals 111, which are outputted to the switch unit 120. In some examples, the transformer unit 140 represents an ideal transformer that does not include a leakage inductor and also does not include a magnetizing inductor on the primary side. For example, in an equivalent current, an actual transformer includes an ideal transformer and also includes a leakage inductor and a magnetizing inductor on the primary side. As an example, in an equivalent current, if the inductance of the leakage inductor of an actual transformer is equal to zero and the inductance of the magnetizing inductor of the actual transformer is infinite, the actual transformer is an ideal transformer.

FIG. 2 is a simplified diagram showing a conventional asymmetrical half-bridge flyback switch-mode power converter. The asymmetrical half-bridge flyback switch-mode power converter 100 includes a bridge rectifier 296, capacitors 298, 234, 262, 284 and 286, switches 222, 224 and 252, a primary inductor 240, a secondary winding 244, an auxiliary winding 246, a synchronous rectification controller 254, resistors 272, 274, 276, 278, 282 and 294, a shunt regulator 288 (e.g., TL431), an optocoupler 264, and a controller chip 210. For example, in an equivalent circuit, the primary inductor 240 includes a primary winding 242, a magnetizing inductor 248 with a magnetizing inductance Lm, and a leakage inductor 232 with a leakage inductance Lᵣ. As an example, in an equivalent circuit, the asymmetrical half-bridge flyback switch-mode power converter 100 includes an actual transformer, which includes an ideal transformer and also includes the leakage inductor 232 and the magnetizing inductor 248 on the primary side, wherein the ideal transformer includes the primary winding 242, the secondary winding 244 and the auxiliary winding 246.

The control unit 110 includes the controller chip 210, the switch unit 120 includes the switches 222 and 224, the resonance unit 130 includes the capacitor 234 and the leakage inductor 232 with the leakage inductance Lᵣ, the transformer unit 140 includes the primary winding 242, the secondary winding 244 and the auxiliary winding 246, the rectifying unit 150 includes the switch 252 and the synchronous rectification controller 254, the output unit 160 includes the capacitor 262, and the feedback unit 170 includes the resistors 272, 274, 276 and 278, the capacitors 284 and 286, the shunt regulator 288 (e.g., TL431), and the optocoupler 264. Also, the controller chip 210 include terminals (e.g., pins) 220, 212, 214, 216, and 218. For example, the switch 222 is a transistor (e.g., a metal-oxide-semiconductor field-effect transistor and/or a gallium nitride transistor). As an example, the switch 224 is a transistor (e.g., a metal-oxide-semiconductor field-effect transistor and/or a gallium nitride transistor).

As shown in FIG. 2, the asymmetrical half-bridge flyback switch-mode power converter 100 receives an AC voltage 290 and generates an output voltage 292 (e.g., Vₒᵤₜ) and an output current 293 (e.g., Iₒᵤₜ). For example, the output current 293 has a positive value if the output current 293 flows out of the asymmetrical half-bridge flyback switch-mode power converter 100.

The switch unit 120 includes the switches 222 and 224. The switch 222 includes terminals 256, 226 and 258, and the switch 224 includes terminals 266, 228 and 268. The terminal 256 of the switch 222 receives the input voltage 101 (e.g., Vᵢₙ), and the terminal 268 of the switch 224 is biased to a ground voltage (e.g., zero volt). The terminal 258 of the switch 222 and the terminal 266 of the switch 224 are connected to each other. The switch unit 120 receives one or more control signals 111, which includes a control signal 211 and a control signal 213. The control signal 211 is received by the terminal 226 of the switch 222, and the control signal 213 is received by the terminal 228 of the switch 224. The switch 222 is opened and/or closed by the control signal 211, and the switch 224 is opened and/or closed by the control signal 213. The terminal 258 of the switch 222 and the terminal 266 of the switch 224 are biased to the voltage 121 (e.g., V_{HB}).

The resonance unit 130 includes the capacitor 234 and the leakage inductor 232 with the leakage inductance Lᵣ. A current 233 (e.g., I_{Lr}) flows through the leakage inductor 232 with the leakage inductance Lᵣ. For example, the current 233 (e.g., I_{Lr}) has a positive value if the current 233 flows from the leakage inductor 232 to the magnetizing inductor 248 and/or the primary winding 242. As an example, the current 233 (e.g., I_{Lr}) has a negative value if the current 233 flows from the magnetizing inductor 248 and/or the primary winding 242 to the leakage inductor 232.

One terminal of the leakage inductor 232 receives the voltage 121 from the terminal 258 of the switch 222 and the terminal 266 of the switch 224, and another terminal of the leakage inductor 232 is connected to one terminal of the primary winding 242 and one terminal of the magnetizing inductor 248. Additionally, one terminal of the capacitor 234 is connected to the terminal 268 of the switch 224 and is biased to the ground voltage (e.g., zero volt). Another terminal of the capacitor 234 is connected to another terminal of the primary winding 242 and another terminal of the magnetizing inductor 248. For example, the magnetizing inductor 248 and the primary winding 242 are connected in parallel. As an example, the primary winding 242 is a part of the ideal transformer that also includes the secondary winding 244 and the auxiliary winding 246.

A magnetization current 249 (e.g., I_{Lm}) flows through the magnetizing inductor 248 with the magnetizing inductance Lₘ. For example, the magnetization current 249 (e.g., I_{Lm}) has a positive value if the magnetization current 249 flows from the magnetizing inductor 248 to the capacitor 234. As an example, the magnetization current 249 (e.g., I_{Lm}) has a negative value if the magnetization current 249 flows from the capacitor 234 to the magnetizing inductor 248. Additionally, a current 247 (e.g., Iₚᵣᵢ) flows through the primary winding 242. For example, the current 247 (e.g., Iₚᵣᵢ) has a positive value if the current 247 flows from the primary winding 242 to the capacitor 234. As an example, the current 247 (e.g., Iₚᵣᵢ) has a negative value if the current 247 flows from the capacitor 234 to the primary winding 242. Moreover, the current 233 (e.g., I_{Lr}) is equal to a sum of the magnetization current 249 (e.g., I_{Lm}) and the current 247 (e.g., Iₚᵣᵢ). For example, if the current 247 (e.g., Iₚᵣᵢ) is equal to zero, the current 233 (e.g., I_{Lr}) is equal to the magnetization current 249 (e.g., I_{Lm}). As an example, if the current 247 (e.g., Iₚᵣᵢ) is not equal to zero, the current 233 (e.g., I_{Lr}) is not equal to the magnetization current 249 (e.g., I_{Lm}). Also, a secondary current 245 (e.g., I_{sec}) flows through the secondary winding 244. For example, the secondary current 245 (e.g., I_{sec}) has a positive value if the secondary current 245 flows from the switch 252 to the secondary winding 244. As an example, the secondary current 245 (e.g., I_{sec}) has a negative value if the secondary current 245 flows from the secondary winding 244 to the switch 252.

The auxiliary winding 246 is connected to the resistors 294 and 282, which generate the signal 141 and outputs the signal 141 to the control unit 110. Additionally, the secondary winding 244 is connected to the rectifying unit 150, which includes the switch 252 and the synchronous rectification controller 254. The synchronous rectification controller 254 generates a control signal 253, which is used to open and/or close the switch 252.

The rectifying unit 150 is connected to the output unit 160, which is configured to generate the output voltage (e.g., the output voltage 292) and/or the output current (e.g., the output current 293). The output unit 160 includes the capacitor 262, and the capacitor 262 is used to reduce and/or eliminate the ripple in the output voltage (e.g., the output voltage 292). Additionally, the output unit 160 is also connected to the feedback unit 170, which includes the resistors 272, 274, 276 and 278, the capacitors 284 and 286, the shunt regulator 288 (e.g., TL431), and the optocoupler 264. The feedback unit 170 outputs the feedback signal 171 to the control unit 110.

The control unit 110 includes the controller chip 210, which includes the terminals (e.g., pins) 220, 212, 214, 216, and 218. The terminal 220 (e.g., GH) outputs the control signal 211, and the terminal 212 (e.g., GL) outputs the control signal 213. Additionally, the terminal 214 (e.g., AUX) receives the signal 141, and the terminal 216 (e.g., FB) receives the signal 171. Moreover, the terminal 218 (e.g., GND) is biased to the ground voltage (e.g., zero volt).

The asymmetrical half-bridge flyback switch-mode power converter 100 operates in different modes. For example, the asymmetrical half-bridge flyback switch-mode power converter 100 operates in a critical conduction mode (CRM). As an example, the asymmetrical half-bridge flyback switch-mode power converter 100 operates in a discontinuous conduction mode (DCM). For example, the asymmetrical half-bridge flyback switch-mode power converter 100 operates in a burst mode. Also, as shown in FIG. 2, the resonance unit 130 is coupled to the terminals 266 and 268 of the switch 224, but alternatively, the resonance unit 130 is coupled to the terminals 256 and 258 of the switch 222.

Hence it is highly desirable to improve the technique for switch-mode power converters.

### 4. BRIEF SUMMARY OF THE DISCLOSURE

Certain embodiments of the present disclosure are directed to circuits. More particularly, some embodiments of the disclosure provide peak value determination for magnetization currents. Merely by way of example, some embodiments of the disclosure have been applied to asymmetrical half-bridge flyback switch-mode power converters in discontinuous conduction mode. But it would be recognized that the disclosure has a much broader range of applicability.

According to some embodiments, a controller for a power converter includes: an output-voltage detector configured to detect a value of an output voltage of the power converter and generate a detection signal that represents the detected value of the output voltage; and a peak-current-value determination unit configured to receive the detection signal and determine a peak value of a magnetization current for the power converter in a discontinuous conduction mode; wherein the peak-current-value determination unit is further configured to: determine the peak value of the magnetization current for the power converter in the discontinuous conduction mode based on at least information associated with the detected value of the output voltage of the power converter; and generate a peak signal that represents the determined peak value of the magnetization current; wherein, for the power converter, each period of the discontinuous conduction mode includes N consecutive cycles of critical conduction mode and an additional time duration, N being a positive integer.

According to certain embodiments, a controller for a power converter includes: an output-voltage detector configured to detect a value of an output voltage of the power converter and generate a first detection signal that represents the detected value of the output voltage; a peak-current-value determination unit configured to receive the first detection signal and, based on at least information associated with the detected value of the output voltage, determine a peak value of a magnetization current for the power converter, the peak-current-value determination unit being further configured to generate a peak signal that represents the determined peak value of the magnetization current; a threshold-current-value determination unit configured to receive the peak signal, determine a threshold value for an output current of the power converter based at least in part on the peak signal, and generate a threshold signal that represents the determined threshold value; and a mode determination unit configured to receive the threshold signal and determine a mode of operation for the power converter based on at least information associated with the determined threshold value.

According to some embodiments, a method for a power converter includes: detecting a value of an output voltage of the power converter; generating a detection signal that represents the detected value of the output voltage; receiving the detection signal that represents the detected value of the output voltage; determining a peak value of a magnetization current for the power converter in a discontinuous conduction mode based on at least information associated with the detected value of the output voltage of the power converter; and generating a peak signal that represents the determined peak value of the magnetization current for the power converter in the discontinuous conduction mode; wherein, for the power converter, each period of the discontinuous conduction mode includes N consecutive cycles of critical conduction mode and an additional time duration, N being a positive integer.

According to certain embodiments, a method for a power converter, the method comprising: detecting a value of an output voltage of the power converter; generating a first detection signal that represents the detected value of the output voltage; receiving the first detection signal that represents the detected value of the output voltage; determining a peak value of a magnetization current for the power converter based on at least information associated with the detected value of the output voltage; generating a peak signal that represents the determined peak value of the magnetization current; receiving the peak signal; determining a threshold value for an output current of the power converter based at least in part on the peak signal; generating a threshold signal that represents the determined threshold value; receiving the threshold signal that represents the determined threshold value; and determining a mode of operation for the power converter based on at least information associated with the determined threshold value.

Depending upon embodiment, one or more benefits may be achieved. These benefits and various additional objects, features and advantages of the present disclosure can be fully appreciated with reference to the detailed description and accompanying drawings that follow.

### 5. BRIEF DESCRIPTION OF THE DRAWINGS

FIG. 1 is a simplified diagram showing certain components of a conventional asymmetrical half-bridge flyback switch-mode power converter.

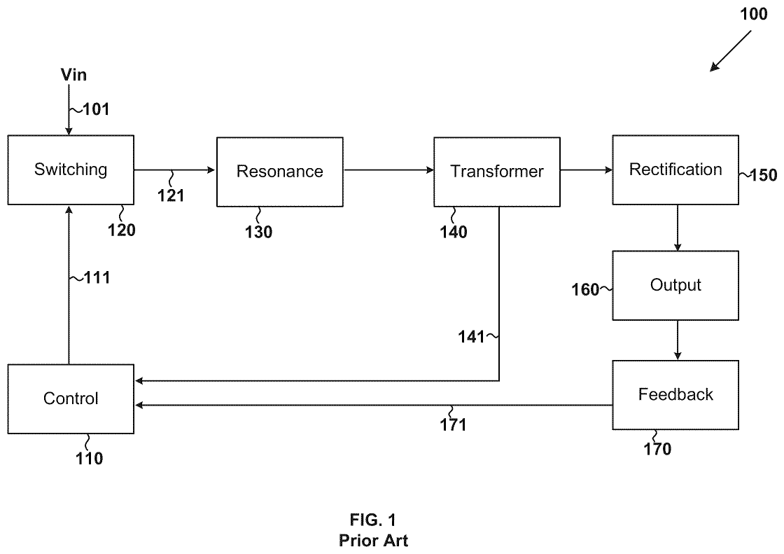

FIG. 2 is a simplified diagram showing a conventional asymmetrical half-bridge flyback switch-mode power converter.

FIG. 3 shows simplified timing diagrams for the conventional asymmetrical half-bridge flyback switch-mode power converter as shown in FIG. 2 in the critical conduction mode (CRM) according to some embodiments.

FIG. 4A shows simplified timing diagrams for the conventional asymmetrical half-bridge flyback switch-mode power converter as shown in FIG. 2 in the discontinuous conduction mode (DCM) with N equal to 1 according to certain embodiments.

FIG. 4B shows simplified timing diagrams for the conventional asymmetrical half-bridge flyback switch-mode power converter as shown in FIG. 2 in the discontinuous conduction mode (DCM) with N equal to 2 according to some embodiments.

FIG. 5 shows simplified timing diagrams for the conventional asymmetrical half-bridge flyback switch-mode power converter as shown in FIG. 2 in the discontinuous conduction mode (DCM) with N equal to 1 if the output voltage changes but the peak value of the magnetization current does not change according to certain embodiments.

FIG. 6A shows simplified efficiency diagrams for the conventional asymmetrical half-bridge flyback switch-mode power converter as shown in FIG. 2 in the discontinuous conduction mode (DCM) and in the critical conduction mode (CRM) if the output voltage is equal to a higher voltage value according to some embodiments.

FIG. 6B shows simplified efficiency diagrams for the conventional asymmetrical half-bridge flyback switch-mode power converter as shown in FIG. 2 in the discontinuous conduction mode (DCM) and in the critical conduction mode (CRM) if the output voltage is equal to a lower voltage value according to certain embodiments.

FIG. 7 is a simplified diagram showing an asymmetrical half-bridge flyback switch-mode power converter according to certain embodiments of the present disclosure.

FIG. 8 is a simplified diagram showing the controller chip of the asymmetrical half-bridge flyback switch-mode power converter as shown in FIG. 7 according to some embodiments of the present disclosure.

FIG. 9 is a simplified diagram showing the logic controller as part of the controller chip of the asymmetrical half-bridge flyback switch-mode power converter as shown in FIG. 7 and FIG. 8 according to certain embodiments of the present disclosure.

FIG. 10 is a simplified diagram showing the peak value of the magnetization current as a function of the output voltage for the peak-current-value determination unit of the logic controller as part of the controller chip of the asymmetrical half-bridge flyback switch-mode power converter as shown in FIG. 7, FIG. 8 and FIG. 9 if the asymmetrical half-bridge flyback switch-mode power converter operates in the discontinuous conduction mode (DCM) according to some embodiments of the present disclosure.

FIG. 11 shows simplified timing diagrams for the peak-current-value determination unit of the logic controller as part of the controller chip of the asymmetrical half-bridge flyback switch-mode power converter as shown in FIG. 7, FIG. 8 and FIG. 9 if the asymmetrical half-bridge flyback switch-mode power converter 700 operates in the discontinuous conduction mode (DCM) with N equal to 1 according to some embodiments of the present disclosure.

FIG. 12 is a simplified diagram showing the threshold value of the output current as a function of the output voltage for the threshold-current-value determination unit of the logic controller as part of the controller chip of the asymmetrical half-bridge flyback switch-mode power converter as shown in FIG. 7, FIG. 8 and FIG. 9 according to some embodiments of the present disclosure.

FIG. 13 is a simplified diagram showing a method for the logic controller as part of the controller chip of the asymmetrical half-bridge flyback switch-mode power converter as shown in FIG. 7, FIG. 8 and FIG. 9 according to certain embodiments of the present disclosure.

### 6. DETAILED DESCRIPTION OF THE DISCLOSURE

Certain embodiments of the present disclosure are directed to circuits. More particularly, some embodiments of the disclosure provide peak value determination for magnetization currents. Merely by way of example, some embodiments of the disclosure have been applied to asymmetrical half-bridge flyback switch-mode power converters in discontinuous conduction mode. But it would be recognized that the disclosure has a much broader range of applicability.

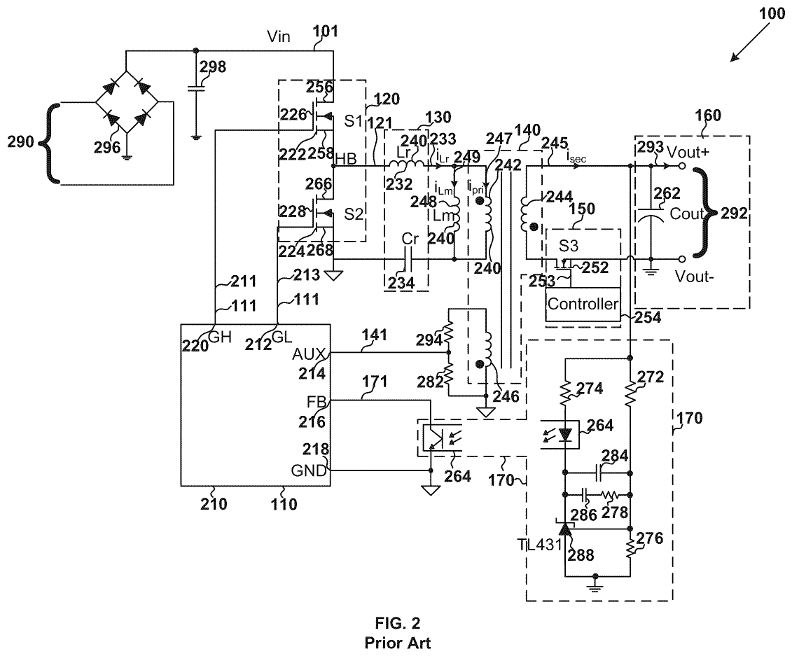

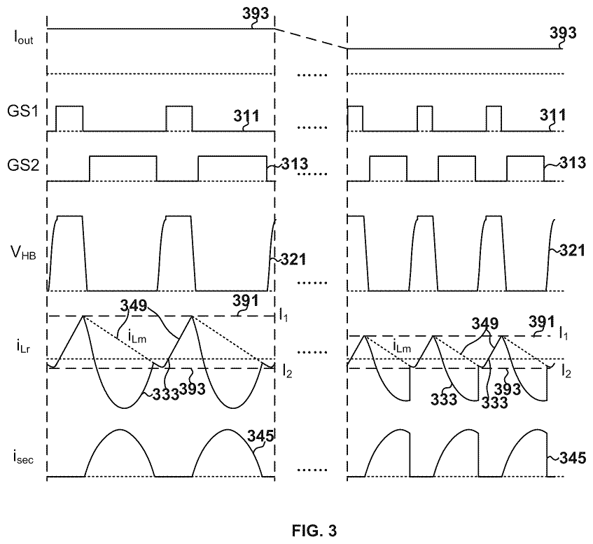

FIG. 3 shows simplified timing diagrams for the conventional asymmetrical half-bridge flyback switch-mode power converter 100 as shown in FIG. 2 in the critical conduction mode (CRM) according to some embodiments. The waveform 393 represents the output current 293 as a function of time, the waveform 311 represents the control signal 211 as a function of time, the waveform 313 represents the control signal 213 as a function of time, the waveform 321 represents the voltage 121 as a function of time, the waveform 333 represents the current 233 as a function of time, the waveform 349 represents the magnetization current 249 as a function of time, and the waveform 345 represents the secondary current 245 as a function of time. In some examples, the conventional asymmetrical half-bridge flyback switch-mode power converter 100 operates in the critical conduction mode (CRM) under heavy load. For example, if the control signal 211 is at a logic high level, the switch 222 is closed, and if the control signal 211 is at a logic low level, the switch 222 is open. As an example, if the control signal 213 is at a logic high level, the switch 224 is closed, and if the control signal 213 is at a logic low level, the switch 224 is open. In certain examples, the waveform 333 is shown as a solid line, and the waveform 349 is shown as a dashed line. For example, when the current 233 (e.g., I_{Lr}) is not equal to the magnetization current 249 (e.g., I_{Lm}), both the solid line and the dashed line are visible in FIG. 3. As an example, when the current 233 (e.g., I_{Lr}) is equal to the magnetization current 249 (e.g., I_{Lm}), the solid line is visible but the dashed line is not visible in FIG. 3.

As shown by the waveform 311, when the control signal 211 is at the logic high level and the switch 222 is closed, the current 233 and the magnetization current 249 are equal to each other as shown by the waveform 333 and the waveform 349 according to certain embodiments. Also as shown by the waveform 313, when the control signal 213 is at the logic high level and the switch 224 is closed, the magnetization current 249 decreases from a current value 391 (e.g., I₁) to a current value 393 (e.g., I₂), wherein the current value 391 is larger than zero and the current level 393 is smaller than zero, according to some embodiments. For example, the current value 391 (e.g., I₁) is the peak value of the magnetization current 249. As an example, the current value 393 (e.g., I₂) is the valley value of the magnetization current 249. In certain examples, in the critical conduction mode (CRM), the current value 393 (e.g., I₂) is adjusted in order to achieve zero-voltage switching for the switch 222.

As shown by the waveforms 311 and 313, when the control signal 211 is at the logic high level and the control signal 213 is at the logic low level, the switch 222 is closed and the switch 224 is open according to certain embodiments. In some examples, if the switch 222 is closed and the switch 224 is open, the input voltage 101 (e.g., Vᵢₙ) stores energy to the actual transformer and the capacitor 234, wherein the actual transformer includes the ideal transformer, the leakage inductor 232 and the magnetizing inductor 248, and the ideal transformer includes the primary winding 242, the secondary winding 244 and the auxiliary winding 246.

Also as shown by the waveforms 311 and 313, when the control signal 211 is at the logic low level and the control signal 213 is at the logic high level, the switch 222 is open and the switch 224 is closed, according to some embodiments. In certain examples, if the switch 222 is open and the switch 224 is closed, through the resonance of the leakage inductor 232 and the capacitor 234 and through the magnetizing inductor 248, the energy is transferred to the secondary side of the actual transformer (e.g., the secondary winding 244).

In certain embodiments, as shown by the waveform 393, the output current 293 is determined as follows:

$${I}_{o u t} = \frac{{N}_{p s}}{2} ( {I}_{1} + {I}_{2} ) \qquad ( Equation 1 )$$

where Iₒᵤₜ represents the output current 293. Additionally, Nₚₛ represents the turns ratio that is equal to the ratio of the number of turns in the primary winding 242 to the number of turns in the secondary winding 244. Moreover, I₁ represents the current value 391, which is the peak value of the magnetization current 249. Also, I₂ represents the current value 393, which is the valley value of the magnetization current 249. For example, according to Equation 1, the current value 391 (e.g., I₁) is adjusted in order to adjust Iₒᵤₜ.

In some embodiments, during the resonance of the leakage inductor 232 and the capacitor 234, the resonance frequency is determined as follows:

$${f}_{r} = \frac{1}{2 π \sqrt{{L}_{r} {C}_{r}}} \qquad ( Equation 2 )$$

where fᵣ represents the resonance frequency. Additionally, Lᵣ represents the inductance of the leakage inductor 232, and Cᵣ represents the capacitance of the capacitor 234. For example, according to Equation 2, the resonance frequency depends on the inductance of the leakage inductor 232 and the capacitance of the capacitor 234. As an example, the resonance period for the resonance of the leakage inductor 232 and the capacitor 234 is determined as follows:

$${T}_{r} = \frac{1}{{f}_{r}} = 2 π \sqrt{{L}_{r} {C}_{r}} \qquad ( Equation 3 )$$

where Tᵣ represents the resonance period. Additionally, Lᵣ represents the inductance of the leakage inductor 232, and Cᵣ represents the capacitance of the capacitor 234.

As shown in FIG. 3, the magnetization current 249 is equal to the current value 391 (e.g., I₁) at the beginning of a demagnetization process, and the magnetization current 249 is equal to the current value 393 (e.g., I₂) at the end of the demagnetization process according to certain embodiments. For example, the time duration for the magnetization current 249 to decreases from the current value 391 (e.g., I₁) to the current value 393 (e.g., I₂) is a demagnetization period. As an example, in order to achieve low-voltage switching and/or zero-voltage switching on both the primary side and the secondary side of the actual transistor, the following condition needs to be satisfied:

$${T}_{d e m} \approx 0.6 \times {T}_{r} \qquad ( Equation 4 )$$

where T_{dem} represents the demagnetization period, and Tᵣ represents the resonance period.

Also as shown in FIG. 3, if the load of the asymmetrical half-bridge flyback switch-mode power converter 100 decreases, the peak value of the magnetization current 249 (e.g., I₁) decreases according to some embodiments. For example, if the load of the asymmetrical half-bridge flyback switch-mode power converter 100 decreases, the demagnetization period also decreases. As an example, if the load of the asymmetrical half-bridge flyback switch-mode power converter 100 decreases, the switching frequency of the asymmetrical half-bridge flyback switch-mode power converter 100 also decreases. In certain examples, as shown by the waveform 313, when the control signal 213 changes from the logic high level to the logic low level and the switch 224 becomes open, the current 233 experiences a sudden change and the secondary current 245 also experiences a sudden change. For example, if the load of the asymmetrical half-bridge flyback switch-mode power converter 100 decreases, when the control signal 213 changes from the logic high level to the logic low level and the switch 224 becomes open, the magnitude of the sudden change in the current 233 and the magnitude of the sudden change in the secondary current 245 become larger. As an example, if the load of the asymmetrical half-bridge flyback switch-mode power converter 100 decreases, the efficiency of the conventional asymmetrical half-bridge flyback switch-mode power converter 100 operates in the critical conduction mode (CRM) becomes lower.

In certain embodiments, when the load of the asymmetrical half-bridge flyback switch-mode power converter 100 is low, the conventional asymmetrical half-bridge flyback switch-mode power converter 100 changes its mode from the critical conduction mode (CRM) to the discontinuous conduction mode (DCM). In some examples, when the conventional asymmetrical half-bridge flyback switch-mode power converter 100 operates in the discontinuous conduction mode (DCM), after N consecutive cycles of critical conduction mode (CRM), both the switch 222 and the switch 224 remain open for a time duration after the demagnetization process has ended, wherein N is a positive integer. For example, after the time duration has ended, the control signal 213 changes from the logic low level to the logic high and the switch 224 becomes closed, in order to reduce the magnetization current 249 to the valley value in order to achieve zero-voltage switching for the switch 222. As an example, after the time duration has ended, the conventional asymmetrical half-bridge flyback switch-mode power converter 100 undergoes another N consecutive cycles of critical conduction mode (CRM). In certain examples, for the conventional asymmetrical half-bridge flyback switch-mode power converter 100, each period of the discontinuous conduction mode (DCM) includes N consecutive cycles of critical conduction mode (CRM) and an additional time duration that follows the N consecutive cycles of critical conduction mode (CRM), wherein N is a positive integer and the additional time duration is larger than zero.

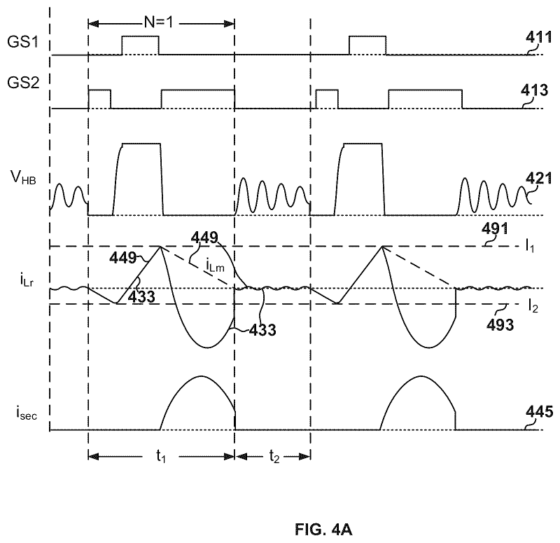

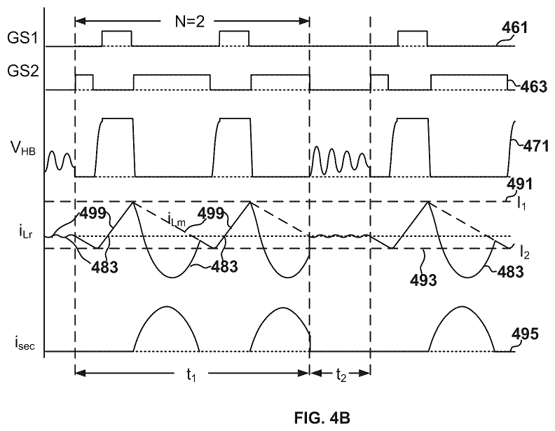

FIG. 4A shows simplified timing diagrams for the conventional asymmetrical half-bridge flyback switch-mode power converter 100 as shown in FIG. 2 in the discontinuous conduction mode (DCM) with N equal to 1 according to certain embodiments. The waveform 411 represents the control signal 211 as a function of time, the waveform 413 represents the control signal 213 as a function of time, the waveform 421 represents the voltage 121 as a function of time, the waveform 433 represents the current 233 as a function of time, the waveform 449 represents the magnetization current 249 as a function of time, and the waveform 445 represents the secondary current 245 as a function of time. In some examples, the waveform 433 is shown as a solid line, and the waveform 449 is shown as a dashed line. For example, when the current 233 (e.g., I_{Lr}) is not equal to the magnetization current 249 (e.g., I_{Lm}), both the solid line and the dashed line are visible in FIG. 4A. As an example, when the current 233 (e.g., I_{Lr}) is equal to the magnetization current 249 (e.g., I_{Lm}), the solid line is visible but the dashed line is not visible in FIG. 4A. For example, the conventional asymmetrical half-bridge flyback switch-mode power converter 100 undergoes one cycle of critical conduction mode (CRM) during a time duration t₁, and after the demagnetization process has ended, both the switch 222 and the switch 224 remain open for a time duration t₂. As an example, the magnetization current 249 changes between the current value 491 (e.g., the peak value) and the current value 493 (e.g., the valley value).

FIG. 4B shows simplified timing diagrams for the conventional asymmetrical half-bridge flyback switch-mode power converter 100 as shown in FIG. 2 in the discontinuous conduction mode (DCM) with N equal to 2 according to some embodiments. The waveform 461 represents the control signal 211 as a function of time, the waveform 463 represents the control signal 213 as a function of time, the waveform 471 represents the voltage 121 as a function of time, the waveform 483 represents the current 233 as a function of time, the waveform 499 represents the magnetization current 249 as a function of time, and the waveform 495 represents the secondary current 245 as a function of time. In some examples, the waveform 483 is shown as a solid line, and the waveform 499 is shown as a dashed line. For example, when the current 233 (e.g., I_{Lr}) is not equal to the magnetization current 249 (e.g., I_{Lm}), both the solid line and the dashed line are visible in FIG. 4B. As an example, when the current 233 (e.g., I_{Lr}) is equal to the magnetization current 249 (e.g., I_{Lm}), the solid line is visible but the dashed line is not visible in FIG. 4B. For example, the conventional asymmetrical half-bridge flyback switch-mode power converter 100 undergoes two consecutive cycles of critical conduction mode (CRM) during a time duration t₁, and after the demagnetization process has ended, both the switch 222 and the switch 224 remain open for a time duration t₂. As an example, the magnetization current 249 changes between the current value 491 (e.g., the peak value) and the current value 493 (e.g., the valley value).

In certain embodiments, as shown in FIG. 4A and FIG. 4B, when the asymmetrical half-bridge flyback switch-mode power converter 100 operates in the discontinuous conduction mode (DCM), the output current 293 is determined as follows:

$${I}_{o u t} = \frac{{N}_{p s}}{2} ( {I}_{1} + {I}_{2} ) \times \frac{{t}_{1}}{{t}_{1} + {t}_{2}} \qquad ( Equation 5 )$$

where Iₒᵤₜ represents the output current 293. Additionally, Nₚₛ represents the turns ratio that is equal to the ratio of the number of turns in the primary winding 242 to the number of turns in the secondary winding 244. Moreover, I₁ represents the current value 491, which is the peak value of the magnetization current 249. Also, I₂ represents the current value 493, which is the valley value of the magnetization current 249. Additionally, t₁ represents the time duration when the conventional asymmetrical half-bridge flyback switch-mode power converter 100 undergoes N consecutive cycles of critical conduction mode (CRM), wherein N is a positive integer.

In some embodiments, according to Equation 5, when the asymmetrical half-bridge flyback switch-mode power converter 100 operates in the discontinuous conduction mode (DCM), even if the load of the asymmetrical half-bridge flyback switch-mode power converter 100 decreases, the peak value of the magnetization current 249 (e.g., I₁) remains constant by increasing the time duration t₂. For example, when the asymmetrical half-bridge flyback switch-mode power converter 100 operates in the discontinuous conduction mode (DCM), even if the load of the asymmetrical half-bridge flyback switch-mode power converter 100 decreases, during each cycle of N consecutive cycles of critical conduction mode (CRM), the demagnetization period satisfies the following condition:

$${T}_{d e m} \approx 0.6 \times {T}_{r} \qquad ( Equation 6 )$$

where T_{dem} represents the demagnetization period, and Tᵣ represents the resonance period.

According to certain embodiments, according to Equation 5, when the asymmetrical half-bridge flyback switch-mode power converter 100 operates in the discontinuous conduction mode (DCM), the output current 293 is reduced by increasing the time duration t₂ but keeping the peak value of the magnetization current 249 (e.g., I₁) constant. For example, even if the peak value of the magnetization current 249 (e.g., I₁) is kept constant, the demagnetization period still changes if the output voltage 292 changes. As an example, the resonance period does not change if the output voltage 292 changes. In some examples, it is challenging to satisfy Equation 6 for various values of the output voltage 292.

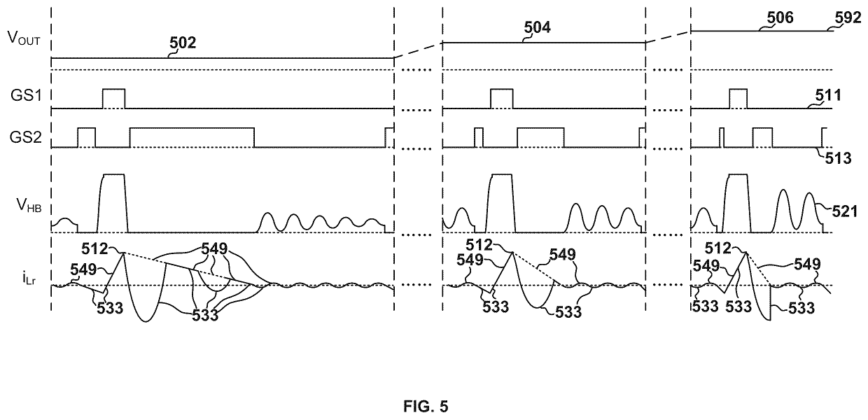

FIG. 5 shows simplified timing diagrams for the conventional asymmetrical half-bridge flyback switch-mode power converter 100 as shown in FIG. 2 in the discontinuous conduction mode (DCM) with N equal to 1 if the output voltage 292 changes but the peak value of the magnetization current 249 does not change according to certain embodiments. The waveform 592 represents the output voltage 292 as a function of time, the waveform 511 represents the control signal 211 as a function of time, the waveform 513 represents the control signal 213 as a function of time, the waveform 521 represents the voltage 121 as a function of time, the waveform 533 represents the current 233 as a function of time, and the waveform 549 represents the magnetization current 249 as a function of time. In some examples, the waveform 533 is shown as a solid line, and the waveform 549 is shown as a dashed line. For example, when the current 233 (e.g., I_{Lr}) is not equal to the magnetization current 249 (e.g., I_{Lm}), both the solid line and the dashed line are visible in FIG. 5. As an example, when the current 233 (e.g., I_{Lr}) is equal to the magnetization current 249 (e.g., I_{Lm}), the solid line is visible but the dashed line is not visible in FIG. 5. In certain examples, the output voltage 292 changes from a voltage value 502 to a voltage value 504 and changes from the voltage value 504 to a voltage value 506. In some examples, the peak value of the magnetization current 249 remains equal to a current value 512, regardless of whether the output voltage 292 is equal to the voltage value 502, the voltage value 504, or the voltage value 506.

In some embodiments, as shown by the waveform 592, when the output voltage 292 is too low (e.g., at the voltage value 502), the demagnetization period (e.g., T_{dem}) is too long as shown by the waveform 549. For example, as shown by the waveform 592, when the output voltage 292 is too low (e.g., at the voltage value 502), the demagnetization period (e.g., T_{dem}) does not satisfy Equation 6 as shown by the waveform 549. As an example, as shown by the waveform 592, when the output voltage 292 is too low (e.g., at the voltage value 502), the efficiency of the conventional asymmetrical half-bridge flyback switch-mode power converter 100 is low.

In certain embodiments, as shown by the waveform 592, when the output voltage 292 is not too low and is not too high (e.g., at the voltage value 504), the demagnetization period (e.g., T_{dem}) is not too long and is not too short as shown by the waveform 549. For example, as shown by the waveform 592, when the output voltage 292 is not too low and is not too high (e.g., at the voltage value 504), the demagnetization period (e.g., T_{dem}) satisfies Equation 6 as shown by the waveform 549. As an example, as shown by the waveform 592, when the output voltage 292 is not too low and is not too high (e.g., at the voltage value 504), the efficiency of the conventional asymmetrical half-bridge flyback switch-mode power converter 100 is high.

In some embodiments, as shown by the waveform 592, when the output voltage 292 is too high (e.g., at the voltage value 506), the demagnetization period (e.g., T_{dem}) is too short as shown by the waveform 549. For example, as shown by the waveform 592, when the output voltage 292 is too high (e.g., at the voltage value 506), the demagnetization period (e.g., T_{dem}) does not satisfy Equation 6 as shown by the waveform 549. As an example, as shown by the waveform 592, when the output voltage 292 is too high (e.g., at the voltage value 506), the efficiency of the conventional asymmetrical half-bridge flyback switch-mode power converter 100 is low.

According to certain embodiments, the threshold value of the output current 293, at which the efficiency of the asymmetrical half-bridge flyback switch-mode power converter 100 in the discontinuous conduction mode (DCM) and the efficiency of the asymmetrical half-bridge flyback switch-mode power converter 100 in the critical conduction mode (CRM) becomes equal, changes with the output voltage 292. For example, if the output current 293 is smaller than the threshold value, the asymmetrical half-bridge flyback switch-mode power converter 100 operates in the discontinuous conduction mode (DCM). As an example, if the output current 293 is larger than the threshold value, the asymmetrical half-bridge flyback switch-mode power converter 100 operates in the critical conduction mode (CRM). In some examples, when the output current 293 becomes larger than the threshold value, the asymmetrical half-bridge flyback switch-mode power converter 100 changes from the discontinuous conduction mode (DCM) to the critical conduction mode (CRM).

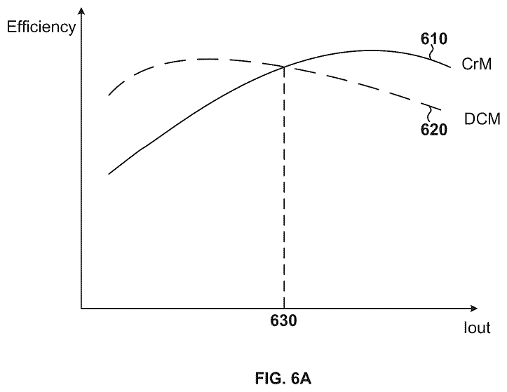

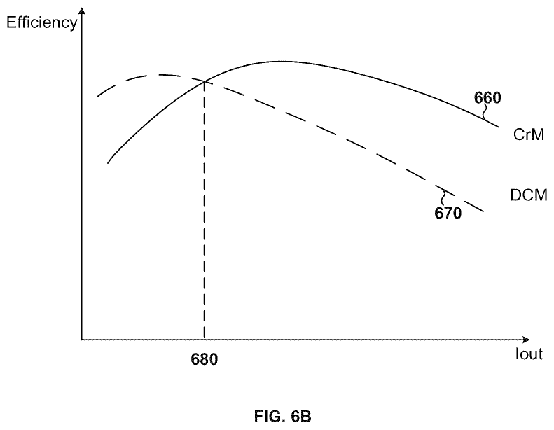

FIG. 6A shows simplified efficiency diagrams for the conventional asymmetrical half-bridge flyback switch-mode power converter 100 as shown in FIG. 2 in the discontinuous conduction mode (DCM) and in the critical conduction mode (CRM) if the output voltage 292 is equal to a higher voltage value according to some embodiments. The waveform 610 represents the efficiency of the conventional asymmetrical half-bridge flyback switch-mode power converter 100 as a function of the output current 293 in the critical conduction mode (CRM), and the waveform 620 represents the efficiency of the conventional asymmetrical half-bridge flyback switch-mode power converter 100 as a function of the output current 293 in the discontinuous conduction mode (DCM). For example, if the output current 293 is equal to a current value 630, the efficiency of the asymmetrical half-bridge flyback switch-mode power converter 100 in the critical conduction mode (CRM) is equal to the efficiency of the asymmetrical half-bridge flyback switch-mode power converter 100 in the discontinuous conduction mode (DCM) as shown by the waveforms 610 and 620. As an example, the current value 630 is the threshold value of the output current 293, at which the efficiency of the asymmetrical half-bridge flyback switch-mode power converter 100 in the discontinuous conduction mode (DCM) and the efficiency of the asymmetrical half-bridge flyback switch-mode power converter 100 in the critical conduction mode (CRM) becomes equal.

FIG. 6B shows simplified efficiency diagrams for the conventional asymmetrical half-bridge flyback switch-mode power converter 100 as shown in FIG. 2 in the discontinuous conduction mode (DCM) and in the critical conduction mode (CRM) if the output voltage 292 is equal to a lower voltage value according to certain embodiments. The waveform 660 represents the efficiency of the conventional asymmetrical half-bridge flyback switch-mode power converter 100 as a function of the output current 293 in the critical conduction mode (CRM), and the waveform 670 represents the efficiency of the conventional asymmetrical half-bridge flyback switch-mode power converter 100 as a function of the output current 293 in the discontinuous conduction mode (DCM). For example, if the output current 293 is equal to a current value 680, the efficiency of the asymmetrical half-bridge flyback switch-mode power converter 100 in the critical conduction mode (CRM) is equal to the efficiency of the asymmetrical half-bridge flyback switch-mode power converter 100 in the discontinuous conduction mode (DCM) as shown by the waveforms 660 and 670. As an example, the current value 680 is the threshold value of the output current 293, at which the efficiency of the asymmetrical half-bridge flyback switch-mode power converter 100 in the discontinuous conduction mode (DCM) and the efficiency of the asymmetrical half-bridge flyback switch-mode power converter 100 in the critical conduction mode (CRM) becomes equal.

In some embodiments, the output voltage 292 of FIG. 6A is higher than the output voltage 292 of FIG. 6B. For example, the current value 630 of FIG. 6A is larger than the current value 680 of FIG. 6B. As an example, the threshold value of the output current 293 in FIG. 6A is higher than the threshold value of the output current 293 in FIG. 6B. In some examples, the threshold value of the output current 293 decreases with the decreasing output voltage 292.

According to certain embodiments, in order to achieve high efficiency of an asymmetrical half-bridge flyback switch-mode power converter, the peak value of a magnetization current of the asymmetrical half-bridge flyback switch-mode power converter changes if the output voltage of the asymmetrical half-bridge flyback switch-mode power converter changes, so that the following condition is satisfied:

$${T}_{d e m} \approx 0.6 \times {T}_{r} \qquad ( Equation 7 )$$

where T_{dem} represents a demagnetization period of the asymmetrical half-bridge flyback switch-mode power converter, and Tᵣ represents a resonance period of the asymmetrical half-bridge flyback switch-mode power converter. For example, by changing the peak value of the magnetization current of the asymmetrical half-bridge flyback switch-mode power converter with the changing output voltage, Equation 7 remains satisfied in order to maintain the high efficiency of the asymmetrical half-bridge flyback switch-mode power converter for various values of the output voltage.

According to some embodiments, in order to achieve high efficiency of an asymmetrical half-bridge flyback switch-mode power converter, the threshold value of an output current of the asymmetrical half-bridge flyback switch-mode power converter decreases if the output voltage of the asymmetrical half-bridge flyback switch-mode power converter decreases.

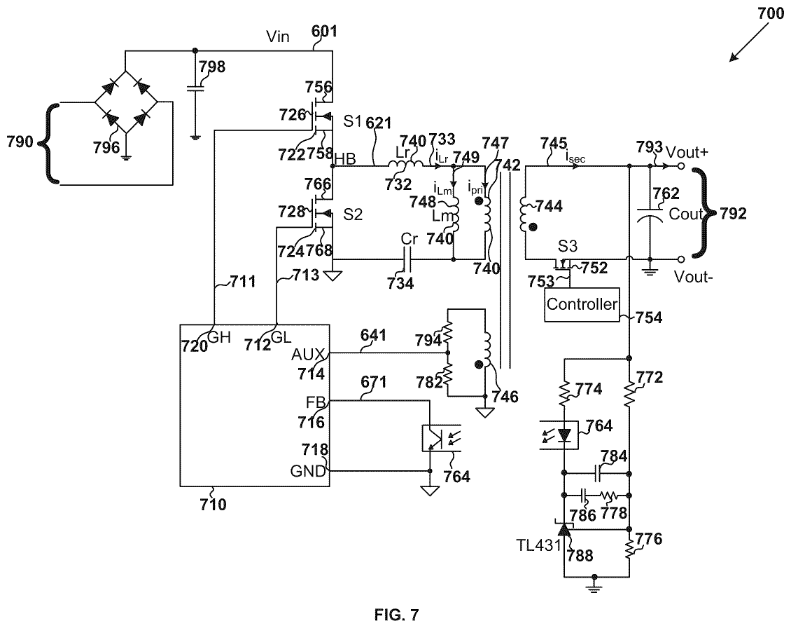

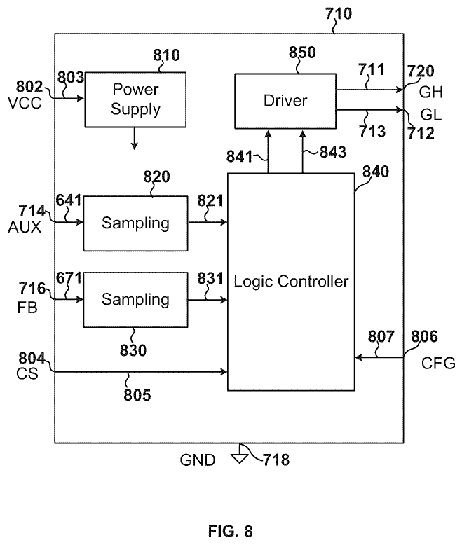

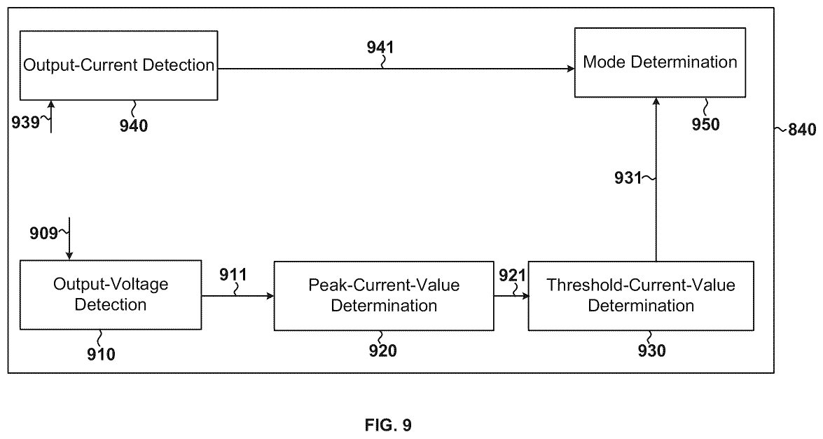

FIG. 7 is a simplified diagram showing an asymmetrical half-bridge flyback switch-mode power converter according to certain embodiments of the present disclosure. This diagram is merely an example, which should not unduly limit the scope of the claims. One of ordinary skill in the art would recognize many variations, alternatives, and modifications. The asymmetrical half-bridge flyback switch-mode power converter 700 includes a bridge rectifier 796, capacitors 798, 734, 762, 784 and 786, switches 722, 724 and 752, a primary inductor 740, a secondary winding 744, an auxiliary winding 746, a synchronous rectification controller 754, resistors 772, 774, 776, 778, 782 and 794, a shunt regulator 788 (e.g., TL431), an optocoupler 764, and a controller chip 710. In some examples, the controller chip 710 is implemented according to at least FIG. 8 and FIG. 9. For example, in an equivalent circuit, the primary inductor 740 includes a primary winding 742, a magnetizing inductor 748 with a magnetizing inductance Lₘ, and a leakage inductor 732 with a leakage inductance Lᵣ. As an example, in an equivalent circuit, the asymmetrical half-bridge flyback switch-mode power converter 700 includes an actual transformer, which includes an ideal transformer and also includes the leakage inductor 732 and the magnetizing inductor 748 on the primary side, wherein the ideal transformer includes the primary winding 742, the secondary winding 744 and the auxiliary winding 746. In certain examples, the controller chip 710 include terminals (e.g., pins) 720, 712, 714, 716, and 718. For example, the switch 722 is a transistor (e.g., a metal-oxide-semiconductor field-effect transistor and/or a gallium nitride transistor). As an example, the switch 724 is a transistor (e.g., a metal-oxide-semiconductor field-effect transistor and/or a gallium nitride transistor). Although the above has been shown using a selected group of components for the asymmetrical half-bridge flyback switch-mode power converter, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 7, in an equivalent circuit, the actual transformer of the asymmetrical half-bridge flyback switch-mode power converter 700 includes the ideal transformer and also includes the leakage inductor 732 and the magnetizing inductor 748 according to some embodiments. For example, the ideal transformer includes the primary winding 742, the secondary winding 744 and the auxiliary winding 746, but does not include the leakage inductor 732 and does not include the magnetizing inductor 748. As an example, in an equivalent current, if the inductance of the leakage inductor 732 of the actual transformer is equal to zero and the inductance of the magnetizing inductor 748 of the actual transformer is infinite, the actual transformer is the same as the ideal transformer.

Also as shown in FIG. 7, the asymmetrical half-bridge flyback switch-mode power converter 700 receives an AC voltage 790 and generates an output voltage 792 (e.g., Vₒᵤₜ) and an output current 793 (e.g., Iₒᵤₜ) according to certain embodiments. For example, the output current 793 has a positive value if the output current 793 flows out of the asymmetrical half-bridge flyback switch-mode power converter 700.

In certain embodiments, the switch 722 includes terminals 756, 726 and 758, and the switch 724 includes terminals 766, 728 and 768. For example, the terminal 756 of the switch 722 receives an input voltage 601 (e.g., Vᵢₙ), and the terminal 768 of the switch 724 is biased to a ground voltage (e.g., zero volt). As an example, the input voltage 601 (e.g., Vᵢₙ) is a DC voltage. For example, the terminal 758 of the switch 722 and the terminal 766 of the switch 724 are connected to each other. In some examples, a control signal 711 is received by the terminal 726 of the switch 722, and a control signal 713 is received by the terminal 728 of the switch 724. For example, the switch 722 is opened and/or closed by the control signal 711, and the switch 724 is opened and/or closed by the control signal 713. As an example, the terminal 758 of the switch 722 and the terminal 766 of the switch 724 are biased to a voltage 621 (e.g., V_{HB}).

In some embodiments, a current 733 (e.g., I_{Lr}) flows through the leakage inductor 732 with the leakage inductance Lᵣ. For example, the current 733 (e.g., I_{Lr}) has a positive value if the current 733 flows from the leakage inductor 732 to the magnetizing inductor 748 and/or the primary winding 742. As an example, the current 733 (e.g., I_{Lr}) has a negative value if the current 733 flows from the magnetizing inductor 748 and/or the primary winding 742 to the leakage inductor 732.

According to certain embodiments, one terminal of the leakage inductor 732 receives the voltage 621 from the terminal 758 of the switch 722 and the terminal 766 of the switch 724, and another terminal of the leakage inductor 732 is connected to one terminal of the primary winding 742 and one terminal of the magnetizing inductor 748. In some examples, one terminal of the capacitor 734 is connected to the terminal 768 of the switch 724 and is biased to the ground voltage (e.g., zero volt). In certain examples, another terminal of the capacitor 734 is connected to another terminal of the primary winding 742 and another terminal of the magnetizing inductor 748. For example, the magnetizing inductor 748 and the primary winding 742 are connected in parallel. As an example, the primary winding 742 is a part of the ideal transformer that also includes the secondary winding 744 and the auxiliary winding 746.

According to some embodiments, a magnetization current 749 (e.g., I_{Lm}) flows through the magnetizing inductor 748 with the magnetizing inductance Lₘ. For example, the magnetization current 749 (e.g., I_{Lm}) has a positive value if the magnetization current 749 flows from the magnetizing inductor 748 to the capacitor 734. As an example, the magnetization current 749 (e.g., I_{Lm}) has a negative value if the magnetization current 749 flows from the capacitor 734 to the magnetizing inductor 748. In certain examples, a current 747 (e.g., Iₚᵣᵢ) flows through the primary winding 742. For example, the current 747 (e.g., Iₚᵣᵢ) has a positive value if the current 747 flows from the primary winding 742 to the capacitor 734. As an example, the current 747 (e.g., Iₚᵣᵢ) has a negative value if the current 747 flows from the capacitor 734 to the primary winding 742. In some examples, the current 733 (e.g., I_{Lr}) is equal to a sum of the magnetization current 749 (e.g., I_{Lm}) and the current 747 (e.g., Iₚᵣᵢ). For example, if the current 747 (e.g., Iₚᵣᵢ) is equal to zero, the current 733 (e.g., I_{Lr}) is equal to the magnetization current 749 (e.g., I_{Lm}). As an example, if the current 747 (e.g., Iₚᵣᵢ) is not equal to zero, the current 733 (e.g., I_{Lr}) is not equal to the magnetization current 749 (e.g., I_{Lm}). In certain examples, a secondary current 745 (e.g., I_{sec}) flows through the secondary winding 744. For example, the secondary current 745 (e.g., I_{sec}) has a positive value if the secondary current 745 flows from the switch 752 to the secondary winding 744. As an example, the secondary current 745 (e.g., I_{sec}) has a negative value if the secondary current 745 flows from the secondary winding 744 to the switch 752.

In certain embodiments, the auxiliary winding 746 is connected to the resistors 794 and 782, which generate a signal 641 and outputs the signal 641 to the controller chip 710. For example, the secondary winding 744 is connected to the switch 752. As an example, the synchronous rectification controller 754 generates a control signal 753, which is used to open and/or close the switch 752. In some examples, the capacitor 762 is used to reduce and/or eliminate the ripple in the output voltage 792. In certain examples, the output voltage 792 is used to generate a feedback signal 771 that is outputted to the controller chip 710.

In some embodiments, the controller chip 710 includes the terminals (e.g., pins) 720, 712, 714, 716, and 718. For example, the terminal 720 (e.g., GH) outputs the control signal 711, and the terminal 712 (e.g., GL) outputs the control signal 713. As an example, the terminal 714 (e.g., AUX) receives the signal 641, and the terminal 716 (e.g., FB) receives a signal 671. For example, the terminal 718 (e.g., GND) is biased to the ground voltage (e.g., zero volt).

According to certain embodiments, the asymmetrical half-bridge flyback switch-mode power converter 700 operates in different modes. For example, the asymmetrical half-bridge flyback switch-mode power converter 700 operates in a critical conduction mode (CRM). As an example, the asymmetrical half-bridge flyback switch-mode power converter 700 operates in a discontinuous conduction mode (DCM). For example, the asymmetrical half-bridge flyback switch-mode power converter 700 operates in a burst mode.

As mentioned above and further emphasized here, FIG. 7 is merely an example, which should not unduly limit the scope of the claims. One of ordinary skill in the art would recognize many variations, alternatives, and modifications. For example, the bridge rectifier 796 and the capacitor 798 are replaced by another circuit that is also configured to convert the AC voltage 790 to a DC voltage (e.g., the input voltage 601). As an example, a boost PFC circuit is used to convert the AC voltage 790 to a DC voltage (e.g., the input voltage 601).

FIG. 8 is a simplified diagram showing the controller chip 710 of the asymmetrical half-bridge flyback switch-mode power converter 700 as shown in FIG. 7 according to some embodiments of the present disclosure. This diagram is merely an example, which should not unduly limit the scope of the claims. One of ordinary skill in the art would recognize many variations, alternatives, and modifications. The controller chip 710 includes the terminal 720 (e.g., a pin), the terminal 712 (e.g., a pin), the terminal 714 (e.g., a pin), the terminal 716 (e.g., a pin), and the terminal 718 (e.g., a pin), and the controller chip 710 also includes a terminal 802 (e.g., a pin), a terminal 804 (e.g., a pin), and a terminal 806 (e.g., a pin). Additionally, the controller chip 710 includes a power supply unit 810, a sampling unit 820, a sampling unit 830, a logic controller 840, and a driver 850. For example, the logic controller 840 of the controller chip 710 is implemented according to at least FIG. 9. Although the above has been shown using a selected group of components for the controller chip, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

For example, the power supply unit 810 is implemented using one or more software components, one or more hardware components, and/or one or more combinations of software and hardware components, and/or the power supply unit 810 is implemented in one or more circuits, such as one or more analog circuits and/or one or more digital circuits. As an example, the sampling unit 820 is implemented using one or more software components, one or more hardware components, and/or one or more combinations of software and hardware components, and/or the sampling unit 820 is implemented in one or more circuits, such as one or more analog circuits and/or one or more digital circuits. For example, the sampling unit 830 is implemented using one or more software components, one or more hardware components, and/or one or more combinations of software and hardware components, and/or the sampling unit 830 is implemented in one or more circuits, such as one or more analog circuits and/or one or more digital circuits. As an example, the logic controller 840 is implemented using one or more software components, one or more hardware components, and/or one or more combinations of software and hardware components, and/or the logic controller 840 is implemented in one or more circuits, such as one or more analog circuits and/or one or more digital circuits. For example, the driver 850 is implemented using one or more software components, one or more hardware components, and/or one or more combinations of software and hardware components, and/or the driver 850 is implemented in one or more circuits, such as one or more analog circuits and/or one or more digital circuits.

In certain embodiments, the power supply unit 810 is connected to the terminal 802 (e.g., VCC). For example, the power supply unit 810 receives a chip supply voltage 803 (e.g., V_{cc}) from the terminal 802. As an example, the power supply unit 810 provides power to one or more other components of the controller chip 710. In some embodiments, the sampling unit 820 is connected to the terminal 714 (e.g., AUX). For example, the sampling unit 820 receives the signal 641 from the terminal 714. As an example, the sampling unit 820 samples the signal 641 and generates a sampled signal 821.

According to certain embodiments, the sampling unit 830 is connected to the terminal 716 (e.g., FB). For example, the sampling unit 830 receives the signal 671 from the terminal 716. As an example, the sampling unit 830 samples the signal 671 and generates a sampled signal 831. According to some embodiments, the logic controller 840 is connected to the terminal 804 (e.g., CS) and the terminal 806 (e.g., CFG). For example, the logic controller 840 receives a signal 805 from the terminal 804, wherein the signal 805 represents the current 733 (e.g., I_{Lr}). As an example, the logic controller 840 receives a signal 807 from the terminal 806, wherein the signal 807 is used to adjust one or more operation parameters of the controller chip 710. In certain examples, the logic controller 840 receives the signals 821, 831, 805 and 807, and generates signals 841 and 843.

In certain embodiments, the driver 850 is connected to the terminal 720 (e.g., GH) and the terminal 712 (e.g., GL). For example, the driver 850 receives the signals 841 and 843. In some examples, the driver 850 generates the control signal 711 and the control signal 713. For example, the driver 850 outputs the control signal 711 at the terminal 720. As an example, the driver 850 outputs the control signal 713 at the terminal 712.

FIG. 9 is a simplified diagram showing the logic controller 840 as part of the controller chip 710 of the asymmetrical half-bridge flyback switch-mode power converter 700 as shown in FIG. 7 and FIG. 8 according to certain embodiments of the present disclosure. This diagram is merely an example, which should not unduly limit the scope of the claims. One of ordinary skill in the art would recognize many variations, alternatives, and modifications. The logic controller 840 includes an output-voltage detector 910, a peak-current-value determination unit 920, a threshold-current-value determination unit 930, an output-current detector 940, and a mode determination unit 950. For example, the peak-current-value determination unit 920 is implemented using one or more software components, one or more hardware components, and/or one or more combinations of software and hardware components, and/or the peak-current-value determination unit 920 is implemented in one or more circuits, such as one or more analog circuits and/or one or more digital circuits. As an example, the threshold-current-value determination unit 930 is implemented using one or more software components, one or more hardware components, and/or one or more combinations of software and hardware components, and/or the threshold-current-value determination unit 930 is implemented in one or more circuits, such as one or more analog circuits and/or one or more digital circuits. For example, the mode determination unit 950 is implemented using one or more software components, one or more hardware components, and/or one or more combinations of software and hardware components, and/or the mode determination unit 950 is implemented in one or more circuits, such as one or more analog circuits and/or one or more digital circuits. Although the above has been shown using a selected group of components for the logic controller, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some embodiments, the output-voltage detector 910 receives a signal 909 and detects the value of the output voltage 792 (e.g., Vₒᵤₜ) based at least in part on the signal 909. For example, the signal 909 represents the signal 641 that is associated with the auxiliary winding 746, and the output-voltage detector 910 detects the value of the output voltage 792 (e.g., Vₒᵤₜ) based on at least information associated with the signal 641. As an example, the signal 909 represents a voltage difference between two terminals of the capacitor 734, and the output-voltage detector 910 detects the value of the output voltage 792 (e.g., Vₒᵤₜ) based on at least information associated with the voltage difference between two terminals of the capacitor 734. In certain examples, the output-voltage detector 910 generates a signal 911 (e.g., a detection signal) that represents the detected value of the output voltage 792.

In certain embodiments, the peak-current-value determination unit 920 receives the signal 911 that represents the detected value of the output voltage 792 and determines a peak value of the magnetization current 749 based at least in part on the signal 911. In some examples, the determined peak value of the magnetization current 749 is the peak value of the magnetization current 749 if the asymmetrical half-bridge flyback switch-mode power converter 700 operates in the discontinuous conduction mode (DCM). For example, the peak-current-value determination unit 920 determines the peak value of the magnetization current 749 based on at least information associated with the detected value of the output voltage 792. As an example, the peak-current-value determination unit 920 generates a signal 921 (e.g., a peak signal) that represents the determined peak value of the magnetization current 749.

In certain examples, when the asymmetrical half-bridge flyback switch-mode power converter 700 operates in the discontinuous conduction mode (DCM), after N consecutive cycles of critical conduction mode (CRM), both the switch 722 and the switch 724 remain open for a time duration after the demagnetization process has ended, wherein N is a positive integer. For example, after the time duration has ended, the control signal 713 changes from the logic low level to the logic high and the switch 724 becomes closed, in order to reduce the magnetization current 749 to the valley value in order to achieve zero-voltage switching for the switch 722. As an example, after the time duration has ended, the asymmetrical half-bridge flyback switch-mode power converter 700 undergoes another N consecutive cycles of critical conduction mode (CRM). In certain examples, for the asymmetrical half-bridge flyback switch-mode power converter 700, each period of the discontinuous conduction mode (DCM) includes N consecutive cycles of critical conduction mode (CRM) and an additional time duration that follows the N consecutive cycles of critical conduction mode (CRM), wherein N is a positive integer and the additional time duration is larger than zero.

In some examples, if the asymmetrical half-bridge flyback switch-mode power converter 700 operates in the discontinuous conduction mode (DCM), the determined peak value of the magnetization current 749 changes with the detected value of the output voltage 792. For example, when the asymmetrical half-bridge flyback switch-mode power converter 700 operates in the discontinuous conduction mode (DCM), if the detected value of the output voltage 792 increases, the peak value of the magnetization current 749 also increases. As an example, when the asymmetrical half-bridge flyback switch-mode power converter 700 operates in the discontinuous conduction mode (DCM), if the detected value of the output voltage 792 decreases, the peak value of the magnetization current 749 also decreases.

In certain examples, the peak-current-value determination unit 920 determines the peak value of the magnetization current 749 so that for the asymmetrical half-bridge flyback switch-mode power converter 700 in the discontinuous conduction mode (DCM), the following condition is satisfied:

$${T}_{d e m} \approx 0.6 \times {T}_{r} \qquad ( Equation 8 )$$

where T_{dem} represents a demagnetization period of the asymmetrical half-bridge flyback switch-mode power converter 700, and Tᵣ represents a resonance period of the asymmetrical half-bridge flyback switch-mode power converter 700.

In some examples, when the asymmetrical half-bridge flyback switch-mode power converter 700 operates in the discontinuous conduction mode (DCM), by changing the peak value of the magnetization current 749 of the asymmetrical half-bridge flyback switch-mode power converter 700 with the changing output voltage 792, Equation 8 remains satisfied for various values of the output voltage 792. In certain examples, when the asymmetrical half-bridge flyback switch-mode power converter 700 operates in the discontinuous conduction mode (DCM), by changing the peak value of the magnetization current 749 of the asymmetrical half-bridge flyback switch-mode power converter 700 with the changing detected value of the output voltage 792, Equation 8 remains satisfied regardless of a change in the detected value of the output voltage 792.

For example, when the asymmetrical half-bridge flyback switch-mode power converter 700 operates in the discontinuous conduction mode (DCM), if the detected value of the output voltage 792 increases, the determined peak value of the magnetization current 749 also increases. As an example, when the asymmetrical half-bridge flyback switch-mode power converter 700 operates in the discontinuous conduction mode (DCM), if the detected value of the output voltage 792 decreases, the determined peak value of the magnetization current 749 also decreases.

In some embodiments, the threshold-current-value determination unit 930 receives the signal 921 that represents the determined peak value of the magnetization current 749 and determines a threshold value of the output current 793 based at least in part on the signal 921. For example, the threshold-current-value determination unit 930 determines the threshold value of the output current 793 based on at least information associated with the determined peak value of the magnetization current 749. As an example, the threshold-current-value determination unit 930 generates a signal 931 (e.g., a threshold signal) that represents the determined threshold value of the output current 793.

In certain examples, the determined threshold value of the output current 793 changes with the changing determined peak value of the magnetization current 749. For example, if the determined peak value of the magnetization current 749 increases, the determined threshold value of the output current 793 also increases. As an example, if the determined peak value of the magnetization current 749 decreases, the determined threshold value of the output current 793 also decreases.

In some examples, the determined threshold value of the output current 793 changes with the changing detected value of the output voltage 792. For example, if the detected value of the output voltage 792 increases, the determined threshold value of the output current 793 also increases. As an example, if the detected value of the output voltage 792 decreases, the determined threshold value of the output current 793 also decreases.

In certain embodiments, the output-current detector 940 receives a signal 939 and detects the value of the output current 793 (e.g., Iₒᵤₜ) based at least in part on the signal 939. For example, the signal 939 represents the signal 671 that is associated with the optocoupler 764, and the output-current detector 940 detects the value of the output current 793 (e.g., Iₒᵤₜ) based on at least information associated with the signal 671. As an example, if the signal 671 increases, the detected value of the output current 793 also increases, and if the signal 671 decreases, the detected value of the output current 793 also decreases. In some examples, the output-current detector 940 generates a signal 941 (e.g., a detection signal) that represents the detected value of the output current 793.

In some embodiments, the mode determination unit 950 receives the signal 941 that represents the detected value of the output current 793, and the mode determination unit 950 also receives the signal 931 that represents the determined threshold value of the output current 793. For example, the mode determination unit 950 determines a mode of operation for the asymmetrical half-bridge flyback switch-mode power converter 700 based at least in part on the signal 941 and the signal 931. As an example, the mode determination unit 950 determines a mode of operation for the asymmetrical half-bridge flyback switch-mode power converter 700 based on at least information associated with the detected value of the output current 793 and the determined threshold value of the output current 793. In some examples, if the detected value of the output current 793 is larger than the determined threshold value of the output current 793, the mode determination unit 950 determines the mode of operation for the asymmetrical half-bridge flyback switch-mode power converter 700 to be the critical conduction mode (CRM). In certain examples, if the detected value of the output current 793 is smaller than the determined threshold value of the output current 793, the mode determination unit 950 determines the mode of operation for the asymmetrical half-bridge flyback switch-mode power converter 700 to be the discontinuous conduction mode (DCM).

In some examples, when the asymmetrical half-bridge flyback switch-mode power converter 700 operates in the discontinuous conduction mode (DCM), in response to the detected value of the output current 793 becoming larger than the determined threshold value of the output current 793, the mode determination unit 950 changes the mode of operation for the asymmetrical half-bridge flyback switch-mode power converter 700 from the discontinuous conduction mode (DCM) to the critical conduction mode (CRM). In certain examples, when the asymmetrical half-bridge flyback switch-mode power converter 700 operates in the critical conduction mode (CRM), in response to the detected value of the output current 793 becoming smaller than the determined threshold value of the output current 793, the mode determination unit 950 changes the mode of operation for the asymmetrical half-bridge flyback switch-mode power converter 700 from the critical conduction mode (CRM) to the discontinuous conduction mode (DCM).

As mentioned above and further emphasized here, FIG. 9 is merely an example, which should not unduly limit the scope of the claims. One of ordinary skill in the art would recognize many variations, alternatives, and modifications. In certain embodiments, the mode determination unit 950 determines a mode of operation for the asymmetrical half-bridge flyback switch-mode power converter 700 based on at least information associated with the detected value of the output current 793 and the determined threshold value of the output current 793. For example, if the detected value of the output current 793 is larger than the determined threshold value of the output current 793, the mode determination unit 950 determines the mode of operation for the asymmetrical half-bridge flyback switch-mode power converter 700 to be the critical conduction mode (CRM). As an example, if the detected value of the output current 793 is smaller than the determined threshold value of the output current 793 and is larger than another threshold value of the output current 793, the mode determination unit 950 determines the mode of operation for the asymmetrical half-bridge flyback switch-mode power converter 700 to be the discontinuous conduction mode (DCM). For example, if the detected value of the output current 793 is smaller than this another threshold value of the output current 793, the mode determination unit 950 determines the mode of operation for the asymmetrical half-bridge flyback switch-mode power converter 700 to be a burst mode. In some examples, when the asymmetrical half-bridge flyback switch-mode power converter 700 operates in the discontinuous conduction mode (DCM), in response to the detected value of the output current 793 becoming larger than the determined threshold value of the output current 793, the mode determination unit 950 changes the mode of operation for the asymmetrical half-bridge flyback switch-mode power converter 700 from the discontinuous conduction mode (DCM) to the critical conduction mode (CRM). In certain examples, when the asymmetrical half-bridge flyback switch-mode power converter 700 operates in the critical conduction mode (CRM), in response to the detected value of the output current 793 becoming smaller than the determined threshold value of the output current 793, the mode determination unit 950 changes the mode of operation for the asymmetrical half-bridge flyback switch-mode power converter 700 from the critical conduction mode (CRM) to the discontinuous conduction mode (DCM).

In some embodiments, the mode determination unit 950 determines a mode of operation for the asymmetrical half-bridge flyback switch-mode power converter 700 based on at least information associated with the detected value of the output current 793 and the determined threshold value of the output current 793. For example, when the asymmetrical half-bridge flyback switch-mode power converter 700 operates in the discontinuous conduction mode (DCM), in response to the detected value of the output current 793 becoming larger than a first determined threshold value of the output current 793, the mode determination unit 950 changes the mode of operation for the asymmetrical half-bridge flyback switch-mode power converter 700 from the discontinuous conduction mode (DCM) to the critical conduction mode (CRM). As an example, when the asymmetrical half-bridge flyback switch-mode power converter 700 operates in the critical conduction mode (CRM), in response to the detected value of the output current 793 becoming smaller than a second determined threshold value of the output current 793, the mode determination unit 950 changes the mode of operation for the asymmetrical half-bridge flyback switch-mode power converter 700 from the critical conduction mode (CRM) to the discontinuous conduction mode (DCM). In some examples, the second determined threshold value of the output current 793 is smaller than (e.g., slightly smaller than) the first determined threshold value of the output current 793. For example, by making the first determined threshold value of the output current 793 and the second determined threshold value of the output current 793 unequal, the asymmetrical half-bridge flyback switch-mode power converter 700 can reduce switching back and forth between the critical conduction mode (CRM) and the discontinuous conduction mode (DCM) when the detected value of the output current 793 is close to the first determined threshold value of the output current 793 and/or the second determined threshold value of the output current 793.

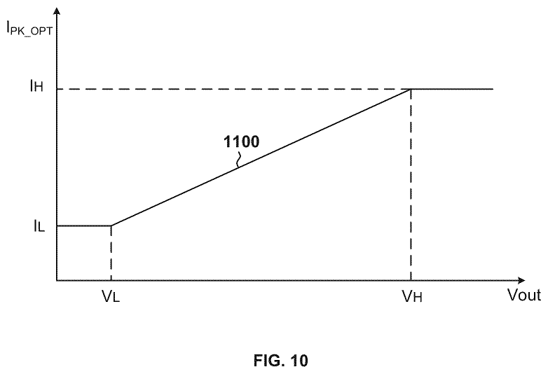

FIG. 10 is a simplified diagram showing the peak value of the magnetization current 749 as a function of the output voltage 792 for the peak-current-value determination unit 920 of the logic controller 840 as part of the controller chip 710 of the asymmetrical half-bridge flyback switch-mode power converter 700 as shown in FIG. 7, FIG. 8 and FIG. 9 if the asymmetrical half-bridge flyback switch-mode power converter 700 operates in the discontinuous conduction mode (DCM) according to some embodiments of the present disclosure. This diagram is merely an example, which should not unduly limit the scope of the claims. One of ordinary skill in the art would recognize many variations, alternatives, and modifications. The waveform 1100 represents the peak value of the magnetization current 749 as a function of the output voltage 792. For example, the peak value of the magnetization current 749 is represented by I_{PK_OPT}, and the output voltage 792 is represented by Vₒᵤₜ. As an example, the output voltage 792 (e.g., Vₒᵤₜ) is represented by the detected value of the output voltage 792, and the detected value of the output voltage 792 is represented by the signal 911.

In certain embodiments, if the output voltage 792 (e.g., Vₒᵤₜ) is larger than or equal to a voltage value V_{L} and is smaller than or equal to a voltage value V_{H}, the peak value (e.g., I_{PK_OPT}) of the magnetization current 749 is determined by the peak-current-value determination unit 920 as follows:

$${I}_{PK\_OPT} = a \times {V}_{o u t} + b \qquad ( Equation 9 )$$

where I_{PK_OPT} represents the peak value of the magnetization current 749 when the asymmetrical half-bridge flyback switch-mode power converter 700 operates in the discontinuous conduction mode (DCM), and Vₒᵤₜ represents the output voltage 792 (e.g., the detected value of the output voltage 792 that is represented by the signal 911). Additionally, a represents a constant, and b represents another constant. For example, the constant a is a positive number.

In some examples, if the detected value of the output voltage 792 that is represented by the signal 911 is larger than or equal to the voltage value V_{L} and is smaller than or equal to the voltage value V_{H}, the peak value of the magnetization current 749 when the asymmetrical half-bridge flyback switch-mode power converter 700 operates in the discontinuous conduction mode (DCM) changes linearly with the changing detected value of the output voltage 792 according to Equation 9. For example, if the detected value of the output voltage 792 that is represented by the signal 911 is larger than or equal to the voltage value V_{L} and is smaller than or equal to the voltage value V_{H}, the peak value of the magnetization current 749 increases linearly with the increasing detected value of the output voltage 792 according to Equation 9. As an example, if the detected value of the output voltage 792 that is represented by the signal 911 is larger than or equal to the voltage value V_{L} and is smaller than or equal to the voltage value V_{H}, the peak value of the magnetization current 749 decreases linearly with the decreasing detected value of the output voltage 792 according to Equation 9.

For example, according to Equation 9, if the detected value of the output voltage 792 that is represented by the signal 911 is equal to the voltage value V_{L}, the peak value (e.g., I_{PK_OPT}) of the magnetization current 749 is equal to a current value I_{L}. As an example, according to Equation 9, if the detected value of the output voltage 792 that is represented by the signal 911 is equal to the voltage value V_{H}, the peak value (e.g., I_{PK_OPT}) of the magnetization current 749 is equal to a current value I_{H}.

In some examples, if the detected value of the output voltage 792 that is represented by the signal 911 is smaller than the voltage value V_{L}, the peak value (e.g., I_{PK_OPT}) of the magnetization current 749 remains constant and equals the current value I_{L} as shown by the waveform 1100. In certain examples, if the detected value of the output voltage 792 that is represented by the signal 911 is larger than the voltage value V_{H}, the peak value (e.g., I_{PK_OPT}) of the magnetization current 749 remains constant and equals the current value I_{H} as shown by the waveform 1100.

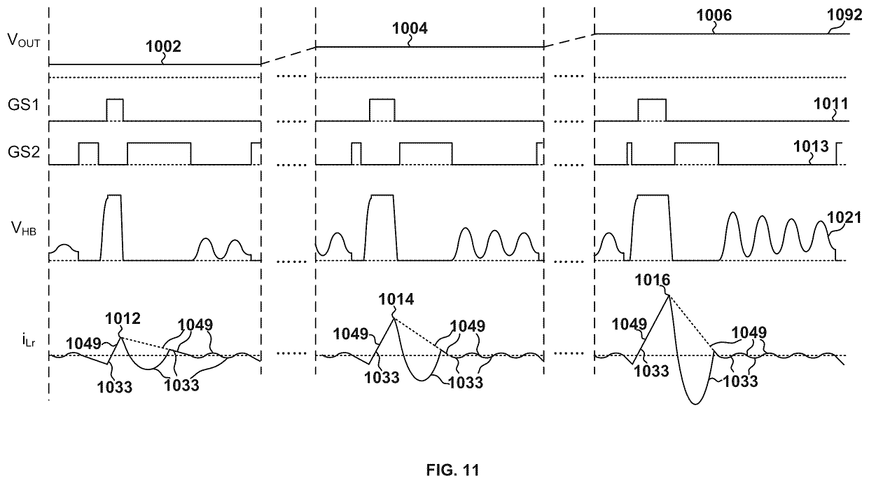

FIG. 11 shows simplified timing diagrams for the peak-current-value determination unit 920 of the logic controller 840 as part of the controller chip 710 of the asymmetrical half-bridge flyback switch-mode power converter 700 as shown in FIG. 7, FIG. 8 and FIG. 9 if the asymmetrical half-bridge flyback switch-mode power converter 700 operates in the discontinuous conduction mode (DCM) with N equal to 1 according to some embodiments of the present disclosure. These diagrams are merely examples, which should not unduly limit the scope of the claims. One of ordinary skill in the art would recognize many variations, alternatives, and modifications. The waveform 1092 represents the output voltage 792 as a function of time, the waveform 1011 represents the control signal 711 as a function of time, the waveform 1013 represents the control signal 713 as a function of time, the waveform 1021 represents the voltage 621 as a function of time, the waveform 1033 represents the current 733 as a function of time, and the waveform 1049 represents the magnetization current 749 as a function of time. In some examples, the waveform 1033 is shown as a solid line, and the waveform 1049 is shown as a dashed line. For example, when the current 733 (e.g., I_{Lr}) is not equal to the magnetization current 749 (e.g., I_{Lm}), both the solid line and the dashed line are visible in FIG. 11. As an example, when the current 733 (e.g., I_{Lr}) is equal to the magnetization current 749 (e.g., I_{Lm}), the solid line is visible but the dashed line is not visible in FIG. 11. In certain examples, referring to the waveform 1092, the output voltage 792 is represented by the detected value of the output voltage 792, and the detected value of the output voltage 792 is represented by the signal 911.

In certain examples, the output voltage 792 changes from a voltage value 1002 to a voltage value 1004 and changes from the voltage value 1004 to a voltage value 1006. For example, the voltage value 1002 is lower than the voltage value 1004, and the voltage value 1004 is lower than the voltage value 1006. In some examples, the peak value of the magnetization current 749 changes with the changing output voltage 792. For example, if the output voltage 792 increases from the voltage value 1002 to the voltage value 1004, the peak value of the magnetization current 749 changes from a current value 1012 to a current value 1014. As an example, if the output voltage 792 increases from the voltage value 1004 to the voltage value 1006, the peak value of the magnetization current 749 changes from the current value 1014 to a current value 1016. In certain examples, when the output voltage 792 increases, the peak value of the magnetization current 749 also increases so that the demagnetization period of the asymmetrical half-bridge flyback switch-mode power converter 700 satisfies the condition as shown by Equation 8 at various values of the output voltage 792.

According to some embodiments, as shown by the waveform 1092, if the output voltage 792 increases from the voltage value 1002 to the voltage value 1004, the peak value of the magnetization current 749 changes from the current value 1012 to the current value 1014 as shown by the waveform 1049, so that the demagnetization period does not change with the changing output voltage 792. For example, the demagnetization period satisfies Equation 8 regardless of whether the output voltage 792 equals the voltage value 1002 or equals the voltage value 1004. As an example, the efficiency of the asymmetrical half-bridge flyback switch-mode power converter 700 remains high regardless of whether the output voltage 792 equals the voltage value 1002 or equals the voltage value 1004.

According to certain embodiments, as shown by the waveform 1092, if the output voltage 792 increases from the voltage value 1004 to the voltage value 1006, the peak value of the magnetization current 749 changes from the current value 1014 to the current value 1016 as shown by the waveform 1049, so that the demagnetization period does not change with the changing output voltage 792. For example, the demagnetization period satisfies Equation 8 regardless of whether the output voltage 792 equals the voltage value 1004 or equals the voltage value 1006. As an example, the efficiency of the asymmetrical half-bridge flyback switch-mode power converter 700 remains high regardless of whether the output voltage 792 equals the voltage value 1004 or equals the voltage value 1006.

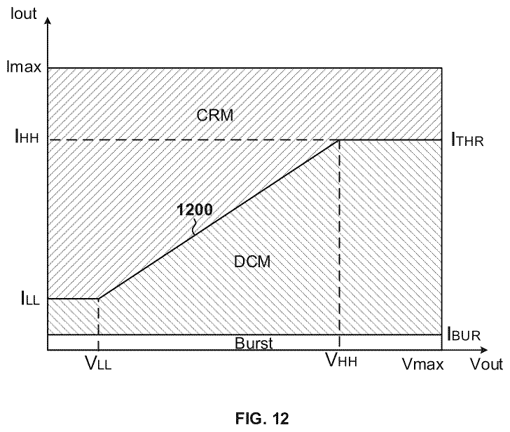

FIG. 12 is a simplified diagram showing the threshold value of the output current 793 as a function of the output voltage 792 for the threshold-current-value determination unit 930 of the logic controller 840 as part of the controller chip 710 of the asymmetrical half-bridge flyback switch-mode power converter 700 as shown in FIG. 7, FIG. 8 and FIG. 9 according to some embodiments of the present disclosure. This diagram is merely an example, which should not unduly limit the scope of the claims. One of ordinary skill in the art would recognize many variations, alternatives, and modifications. The waveform 1200 represents the threshold value of the output current 793 as a function of the output voltage 792. For example, the threshold value of the output current 793 is represented by I_{THR}, and the output voltage 792 is represented by Vₒᵤₜ. As an example, the output voltage 792 (e.g., Vₒᵤₜ) is represented by the detected value of the output voltage 792, and the detected value of the output voltage 792 is represented by the signal 911.

According to certain embodiments, the threshold value (e.g., I_{THR}) of the output current 793 is determined by the threshold-current-value determination unit 930 as follows:

$${I}_{T H R} = c \times {I}_{PK\_OPT} + d \qquad ( Equation 10 )$$

where I_{THR} represents the threshold value of the output current 793, and I_{PK_OPT} represents the peak value of the magnetization current 749 when the asymmetrical half-bridge flyback switch-mode power converter 700 operates in the discontinuous conduction mode (DCM). Additionally, c represents a constant, and d represents another constant. For example, the constant c is a positive number.

In some examples, if the peak value of the magnetization current 749 when the asymmetrical half-bridge flyback switch-mode power converter 700 operates in the discontinuous conduction mode (DCM) changes, the threshold value of the output current 793 changes. For example, the threshold value of the output current 793 increases with the increasing peak value of the magnetization current 749. As an example, the threshold value of the output current 793 decreases with the decreasing peak value of the magnetization current 749.

In some examples, if the detected value of the output voltage 792 changes, the threshold value of the output current 793 changes. For example, the threshold value of the output current 793 increases with the increasing detected value of the output voltage 792. As an example, the threshold value of the output current 793 decreases with the decreasing detected value of the output voltage 792.

In some embodiments, according to Equation 9 and Equation 10, if the detected value of the output voltage 792 (e.g., Vₒᵤₜ) is larger than or equal to a voltage value V_{LL} and is smaller than or equal to a voltage value V_{HH}, the threshold value (e.g., I_{THR}) of the output current 793 changes linearly with the changing detected value of the output voltage 792 (e.g., Vₒᵤₜ), as shown by the waveform 1200. For example, if the detected value of the output voltage 792 (e.g., Vₒᵤₜ) is larger than or equal to the voltage value V_{LL} and is smaller than or equal to the voltage value V_{HH}, the threshold value (e.g., I_{THR}) of the output current 793 increases linearly with the increasing detected value of the output voltage 792 (e.g., Vₒᵤₜ), as shown by the waveform 1200. As an example, if the detected value of the output voltage 792 (e.g., Vₒᵤₜ) is larger than or equal to the voltage value V_{LL} and is smaller than or equal to the voltage value V_{HH}, the threshold value (e.g., I_{THR}) of the output current 793 decreases linearly with the decreasing detected value of the output voltage 792 (e.g., Vₒᵤₜ), as shown by the waveform 1200.

In certain embodiments, if the detected value of the output voltage 792 (e.g., Vₒᵤₜ) is smaller than or equal to the voltage value V_{LL}, the threshold value (e.g., I_{THR}) of the output current 793 remains constant and equals a current value ILL as shown by the waveform 1200. In some example, if the detected value of the output voltage 792 (e.g., Vₒᵤₜ) is larger than or equal to the voltage value V_{HH}, the threshold value (e.g., I_{THR}) of the output current 793 remains constant and equals a current value I_{HH} as shown by the waveform 1200.

According to some embodiments, the mode determination unit 950 determines a mode of operation for the asymmetrical half-bridge flyback switch-mode power converter 700 based on at least information associated with the detected value (e.g., Iₒᵤₜ) of the output current 793 and the determined threshold value (e.g., I_{THR}) of the output current 793. For example, if the detected value (e.g., Iₒᵤₜ) of the output current 793 is larger than the determined threshold value (e.g., I_{THR}) of the output current 793, the mode determination unit 950 determines the mode of operation for the asymmetrical half-bridge flyback switch-mode power converter 700 to be the critical conduction mode (CRM). As an example, if the detected value (e.g., Iₒᵤₜ) of the output current 793 is smaller than the determined threshold value (e.g., I_{THR}) of the output current 793 and is larger than another threshold value (e.g., I_{BUR}) of the output current 793, the mode determination unit 950 determines the mode of operation for the asymmetrical half-bridge flyback switch-mode power converter 700 to be the discontinuous conduction mode (DCM), wherein the determined threshold value (e.g., I_{THR}) is larger than this another threshold value (e.g., I_{BUR}). For example, if the detected value (e.g., Iₒᵤₜ) of the output current 793 is smaller than this another threshold value (e.g., I_{BUR}) of the output current 793, the mode determination unit 950 determines the mode of operation for the asymmetrical half-bridge flyback switch-mode power converter 700 to be a burst mode.

According to certain embodiments, as shown in FIG. 12, Imax represents the maximum value of the output current 793 that is allowed by the asymmetrical half-bridge flyback switch-mode power converter 700, and Vₘₐₓ represents the maximum value of the output voltage 792 that is allowed by the asymmetrical half-bridge flyback switch-mode power converter 700.

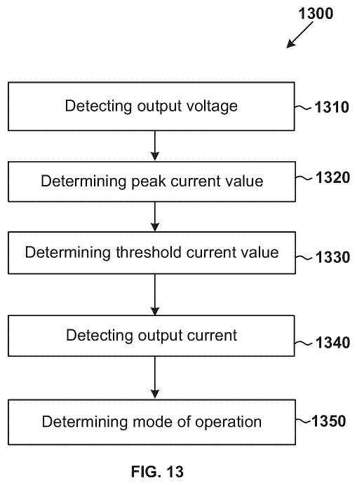

FIG. 13 is a simplified diagram showing a method for the logic controller 840 as part of the controller chip 710 of the asymmetrical half-bridge flyback switch-mode power converter 700 as shown in FIG. 7, FIG. 8 and FIG. 9 according to certain embodiments of the present disclosure. This diagram is merely an example, which should not unduly limit the scope of the claims. One of ordinary skill in the art would recognize many variations, alternatives, and modifications. The method 1300 includes a process 1310 for detecting output voltage, a process 1320 for determining peak current value, a process 1330 for determining threshold current value, a process 1340 for detecting output current, and a process 1350 for determining mode of operation. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present specification.

In some embodiments, at the process 1310, the value of the output voltage 792 (e.g., Vₒᵤₜ) is detected based at least in part on the signal 909, and the signal 911 is generated to represent the detected value of the output voltage 792. In certain examples, the process 1310 is performed by at least the output-voltage detector 910. For example, the signal 909 represents the signal 641 that is associated with the auxiliary winding 746, and the value of the output voltage 792 (e.g., Vₒᵤₜ) is detected based on at least information associated with the signal 641. As an example, the signal 909 represents a voltage difference between two terminals of the capacitor 734, and the value of the output voltage 792 (e.g., Vₒᵤₜ) is detected based on at least information associated with the voltage difference between two terminals of the capacitor 734.

In certain embodiments, at the process 1320, the peak value of the magnetization current 749 is determined based at least in part on the signal 911, and the signal 921 is generated to represent the determined peak value of the magnetization current 749. In some examples, the determined peak value of the magnetization current 749 is the peak value of the magnetization current 749 if the asymmetrical half-bridge flyback switch-mode power converter 700 operates in the discontinuous conduction mode (DCM). For example, the process 1320 is performed by at least the peak-current-value determination unit 920. As an example, the peak value of the magnetization current 749 is determined based on at least information associated with the detected value of the output voltage 792.

In some examples, if the asymmetrical half-bridge flyback switch-mode power converter 700 operates in the discontinuous conduction mode (DCM), the determined peak value of the magnetization current 749 changes with the detected value of the output voltage 792. For example, when the asymmetrical half-bridge flyback switch-mode power converter 700 operates in the discontinuous conduction mode (DCM), if the detected value of the output voltage 792 increases, the peak value of the magnetization current 749 also increases. As an example, when the asymmetrical half-bridge flyback switch-mode power converter 700 operates in the discontinuous conduction mode (DCM), if the detected value of the output voltage 792 decreases, the peak value of the magnetization current 749 also decreases.

In certain examples, the peak-current-value determination unit 920 determines the peak value of the magnetization current 749 so that for the asymmetrical half-bridge flyback switch-mode power converter 700 in the discontinuous conduction mode (DCM), Equation 8 is satisfied. In some examples, by changing the peak value of the magnetization current 749 of the asymmetrical half-bridge flyback switch-mode power converter 700 with the changing output voltage 792, Equation 8 remains satisfied for various values of the output voltage 792 when the asymmetrical half-bridge flyback switch-mode power converter 700 operates in the discontinuous conduction mode (DCM). For example, when the asymmetrical half-bridge flyback switch-mode power converter 700 operates in the discontinuous conduction mode (DCM), if the detected value of the output voltage 792 increases, the determined peak value of the magnetization current 749 also increases. As an example, when the asymmetrical half-bridge flyback switch-mode power converter 700 operates in the discontinuous conduction mode (DCM), if the detected value of the output voltage 792 decreases, the determined peak value of the magnetization current 749 also decreases.

In some embodiments, at the process 1330, the threshold value of the output current 793 is determined based at least in part on the signal 921, and the signal 931 is generated to represent the determined threshold value of the output current 793. In certain examples, the process 1330 is performed by at least the threshold-current-value determination unit 930. For example, the threshold value of the output current 793 is determined based on at least information associated with the determined peak value of the magnetization current 749.

In certain examples, the determined threshold value of the output current 793 changes with the changing determined peak value of the magnetization current 749. For example, if the determined peak value of the magnetization current 749 increases, the determined threshold value of the output current 793 also increases. As an example, if the determined peak value of the magnetization current 749 decreases, the determined threshold value of the output current 793 also decreases.

In some examples, the determined threshold value of the output current 793 changes with the changing detected value of the output voltage 792. For example, if the detected value of the output voltage 792 increases, the determined threshold value of the output current 793 also increases. As an example, if the detected value of the output voltage 792 decreases, the determined threshold value of the output current 793 also decreases.

In certain embodiments, at the process 1340, the value of the output current 793 (e.g., Iₒᵤₜ) is detected based at least in part on the signal 939, and the signal 941 is generated to represent the detected value of the output current 793. In some examples, the process 1340 is performed by at least the output-current detector 940. For example, the signal 939 represents the signal 671 that is associated with the optocoupler 764, and the value of the output current 793 (e.g., Iₒᵤₜ) is detected based on at least information associated with the signal 671. As an example, if the signal 671 increases, the detected value of the output current 793 also increases, and if the signal 671 decreases, the detected value of the output current 793 also decreases.

In some embodiments, at the process 1350, the mode of operation for the asymmetrical half-bridge flyback switch-mode power converter 700 is determined based at least in part on the signal 941 and the signal 931. For example, the process 1350 is performed by at least the mode determination unit 950. As an example, the mode of operation for the asymmetrical half-bridge flyback switch-mode power converter 700 is determined based on at least information associated with the detected value of the output current 793 and the determined threshold value of the output current 793. In some examples, if the detected value of the output current 793 is larger than the determined threshold value of the output current 793, the mode determination unit 950 determines the mode of operation for the asymmetrical half-bridge flyback switch-mode power converter 700 to be the critical conduction mode (CRM). In certain examples, if the detected value of the output current 793 is smaller than the determined threshold value of the output current 793, the mode determination unit 950 determines the mode of operation for the asymmetrical half-bridge flyback switch-mode power converter 700 to be the discontinuous conduction mode (DCM).

As mentioned above and further emphasized here, FIG. 13 is merely an example, which should not unduly limit the scope of the claims. One of ordinary skill in the art would recognize many variations, alternatives, and modifications. In certain embodiments, at the process 1350, the mode of operation for the asymmetrical half-bridge flyback switch-mode power converter 700 is determined based at least in part on the signal 941 and the signal 931. For example, the process 1350 is performed by at least the mode determination unit 950. As an example, the mode of operation for the asymmetrical half-bridge flyback switch-mode power converter 700 is determined based on at least information associated with the detected value of the output current 793 and the determined threshold value of the output current 793. For example, if the detected value of the output current 793 is larger than the determined threshold value of the output current 793, the mode determination unit 950 determines the mode of operation for the asymmetrical half-bridge flyback switch-mode power converter 700 to be the critical conduction mode (CRM). As an example, if the detected value of the output current 793 is smaller than the determined threshold value of the output current 793 and is larger than another threshold value of the output current 793, the mode determination unit 950 determines the mode of operation for the asymmetrical half-bridge flyback switch-mode power converter 700 to be the discontinuous conduction mode (DCM). For example, if the detected value of the output current 793 is smaller than this another threshold value of the output current 793, the mode determination unit 950 determines the mode of operation for the asymmetrical half-bridge flyback switch-mode power converter 700 to be a burst mode.

Certain embodiments of the present disclosure provide a logic controller as part of a controller chip of an asymmetrical half-bridge flyback switch-mode power converter that enables the asymmetrical half-bridge flyback switch-mode power converter to operate at a high efficiency with various values of the output voltage and/or with various values of the output current. For example, the logic controller as part of the controller chip of the asymmetrical half-bridge flyback switch-mode power converter enables the asymmetrical half-bridge flyback switch-mode power converter to operate at a high efficiency with various values of the output voltage and/or with various values of the output power.

According to some embodiments, a controller for a power converter includes: an output-voltage detector configured to detect a value of an output voltage of the power converter and generate a detection signal that represents the detected value of the output voltage; and a peak-current-value determination unit configured to receive the detection signal and determine a peak value of a magnetization current for the power converter in a discontinuous conduction mode; wherein the peak-current-value determination unit is further configured to: determine the peak value of the magnetization current for the power converter in the discontinuous conduction mode based on at least information associated with the detected value of the output voltage of the power converter; and generate a peak signal that represents the determined peak value of the magnetization current; wherein, for the power converter, each period of the discontinuous conduction mode includes N consecutive cycles of critical conduction mode and an additional time duration, N being a positive integer. For example, the controller is implemented according to at least FIG. 9 and/or FIG. 13.

As an example, N is equal to 1. For example, N is equal to 2. As an example, the peak-current-value determination unit is further configured to change the determined peak value of the magnetization current if the detected value of the output voltage of the power converter changes. For example, the peak-current-value determination unit is further configured to: increase the determined peak value of the magnetization current if the detected value of the output voltage of the power converter increases; and decrease the determined peak value of the magnetization current if the detected value of the output voltage of the power converter decreases. As an example, the peak-current-value determination unit is further configured to change the determined peak value of the magnetization current if the detected value of the output voltage of the power converter changes so that a demagnetization period of the power converter satisfies a predetermined condition regardless of a change in the detected value of the output voltage of the power converter.

For example, the peak-current-value determination unit is further configured to, if the detected value of the output voltage is larger than or equal to a first voltage value and is smaller than or equal to a second voltage value, change the determined peak value of the magnetization current linearly with the changing detected value of the output voltage. As an example, the peak-current-value determination unit is further configured to, if the detected value of the output voltage is larger than or equal to the first voltage value and is smaller than or equal to the second voltage value, increase the determined peak value of the magnetization current linearly with the increasing detected value of the output voltage; and decrease the determined peak value of the magnetization current linearly with the decreasing detected value of the output voltage. For example, the peak-current-value determination unit is further configured to: if the detected value of the output voltage is equal to the first voltage value, determine the peak value of the magnetization current to be equal to a first current value; and if the detected value of the output voltage is equal to the second voltage value, determine the peak value of the magnetization current to be equal to a second current value. As an example, the peak-current-value determination unit is further configured to: if the detected value of the output voltage is smaller than the first voltage value, determine the peak value of the magnetization current to be equal to the first current value; and if the detected value of the output voltage is larger than the second voltage value, determine the peak value of the magnetization current to be equal to the second current value.

According to certain embodiments, a controller for a power converter includes: an output-voltage detector configured to detect a value of an output voltage of the power converter and generate a first detection signal that represents the detected value of the output voltage; a peak-current-value determination unit configured to receive the first detection signal and, based on at least information associated with the detected value of the output voltage, determine a peak value of a magnetization current for the power converter, the peak-current-value determination unit being further configured to generate a peak signal that represents the determined peak value of the magnetization current; a threshold-current-value determination unit configured to receive the peak signal, determine a threshold value for an output current of the power converter based at least in part on the peak signal, and generate a threshold signal that represents the determined threshold value; and a mode determination unit configured to receive the threshold signal and determine a mode of operation for the power converter based on at least information associated with the determined threshold value. For example, the controller is implemented according to at least FIG. 9 and/or FIG. 13.

As an example, the controller further includes an output-current detector configured to detect a value of the output current of the power converter and generate a second detection signal that represents the detected value of the output current. For example, the mode determination unit is further configured to receive the second detection signal and determine the mode of operation for the power converter based on at least information associated with the determined threshold value and the detected value of the output current. As an example, the mode determination unit is further configured to, when the power converter operates in a discontinuous conduction mode, in response to the detected value of the output current becoming larger than the determined threshold value, change the mode of operation for the power converter from the discontinuous conduction mode to a critical conduction mode. For example, the mode determination unit is further configured to, when the power converter operates in a critical conduction mode, in response to the detected value of the output current becoming smaller than the determined threshold value, change the mode of operation for the power converter from the critical conduction mode to a discontinuous conduction mode. As an example, wherein, for the power converter, each period of the discontinuous conduction mode includes N consecutive cycles of critical conduction mode and an additional time duration, N being a positive integer.

For example, the threshold-current-value determination unit is further configured to change the determined threshold value for the output current if the determined peak value of the magnetization current changes. As an example, the threshold-current-value determination unit is further configured to: increase the determined threshold value for the output current if the determined peak value of the magnetization current increases; and decrease the determined threshold value for the output current if the determined peak value of the magnetization current decreases. For example, the threshold-current-value determination unit is further configured to, change the determined threshold value for the output current linearly with the changing determined peak value of the magnetization current.

As an example, the threshold-current-value determination unit is further configured to change the determined threshold value for the output current if the detected value of the output voltage of the power converter changes. For example, the threshold-current-value determination unit is further configured to: increase the determined threshold value for the output current if the detected value of the output voltage of the power converter increases; and decrease the determined threshold value for the output current if the detected value of the output voltage of the power converter decreases.

As an example, the threshold-current-value determination unit is further configured to, if the detected value of the output voltage is larger than or equal to a first voltage value and is smaller than or equal to a second voltage value, change the determined threshold value for the output current linearly with the changing detected value of the output voltage. For example, the threshold-current-value determination unit is further configured to, if the detected value of the output voltage is larger than or equal to the first voltage value and is smaller than or equal to the second voltage value, increase the determined threshold value for the output current linearly with the increasing detected value of the output voltage; and decrease the determined threshold value for the output current linearly with the decreasing detected value of the output voltage. As an example, the threshold-current-value determination unit is further configured to: if the detected value of the output voltage is equal to the first voltage value, determine the threshold value for the output current to be equal to a first current value; and if the detected value of the output voltage is equal to the second voltage value, determine the threshold value for the output current to be equal to a second current value. For example, the threshold-current-value determination unit is further configured to: if the detected value of the output voltage is smaller than the first voltage value, determine the threshold value for the output current to be equal to the first current value; and if the detected value of the output voltage is larger than the second voltage value, determine the threshold value for the output current to be equal to the second current value.

According to some embodiments, a method for a power converter includes: detecting a value of an output voltage of the power converter; generating a detection signal that represents the detected value of the output voltage; receiving the detection signal that represents the detected value of the output voltage; determining a peak value of a magnetization current for the power converter in a discontinuous conduction mode based on at least information associated with the detected value of the output voltage of the power converter; and generating a peak signal that represents the determined peak value of the magnetization current for the power converter in the discontinuous conduction mode; wherein, for the power converter, each period of the discontinuous conduction mode includes N consecutive cycles of critical conduction mode and an additional time duration, N being a positive integer. For example, the method is implemented according to at least FIG. 9 and/or FIG. 13.

According to certain embodiments, a method for a power converter, the method comprising: detecting a value of an output voltage of the power converter; generating a first detection signal that represents the detected value of the output voltage; receiving the first detection signal that represents the detected value of the output voltage; determining a peak value of a magnetization current for the power converter based on at least information associated with the detected value of the output voltage; generating a peak signal that represents the determined peak value of the magnetization current; receiving the peak signal; determining a threshold value for an output current of the power converter based at least in part on the peak signal; generating a threshold signal that represents the determined threshold value; receiving the threshold signal that represents the determined threshold value; and determining a mode of operation for the power converter based on at least information associated with the determined threshold value. For example, the method is implemented according to at least FIG. 9 and/or FIG. 13.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A controller for a power converter, the controller comprising:
an output-voltage detector configured to detect a value of an output voltage of the power converter and generate a detection signal that represents the detected value of the output voltage; and
a peak-current-value determination unit configured to receive the detection signal and determine a peak value of a magnetization current for the power converter in a discontinuous conduction mode;
wherein the peak-current-value determination unit is further configured to:
determine the peak value of the magnetization current for the power converter in the discontinuous conduction mode based on at least information associated with the detected value of the output voltage of the power converter; and
generate a peak signal that represents the determined peak value of the magnetization current;
wherein, for the power converter, each period of the discontinuous conduction mode includes N consecutive cycles of critical conduction mode and an additional time duration, N being a positive integer.

2. The controller of claim 1 wherein N is equal to 1.

3. The controller of claim 1 wherein N is equal to 2.

4. The controller of claim 1 wherein the peak-current-value determination unit is further configured to change the determined peak value of the magnetization current if the detected value of the output voltage of the power converter changes.

5. The controller of claim 4 wherein the peak-current-value determination unit is further configured to:
increase the determined peak value of the magnetization current if the detected value of the output voltage of the power converter increases; and
decrease the determined peak value of the magnetization current if the detected value of the output voltage of the power converter decreases.

6. The controller of claim 4 wherein the peak-current-value determination unit is further configured to change the determined peak value of the magnetization current if the detected value of the output voltage of the power converter changes so that a demagnetization period of the power converter satisfies a predetermined condition regardless of a change in the detected value of the output voltage of the power converter.

7. The controller of claim 1 wherein the peak-current-value determination unit is further configured to, if the detected value of the output voltage is larger than or equal to a first voltage value and is smaller than or equal to a second voltage value, change the determined peak value of the magnetization current linearly with the changing detected value of the output voltage.

8. The controller of claim 7 wherein the peak-current-value determination unit is further configured to, if the detected value of the output voltage is larger than or equal to the first voltage value and is smaller than or equal to the second voltage value,
increase the determined peak value of the magnetization current linearly with the increasing detected value of the output voltage; and
decrease the determined peak value of the magnetization current linearly with the decreasing detected value of the output voltage.

9. The controller of claim 7 wherein the peak-current-value determination unit is further configured to:
if the detected value of the output voltage is equal to the first voltage value, determine the peak value of the magnetization current to be equal to a first current value; and
if the detected value of the output voltage is equal to the second voltage value, determine the peak value of the magnetization current to be equal to a second current value.

10. The controller of claim 9 wherein the peak-current-value determination unit is further configured to:
if the detected value of the output voltage is smaller than the first voltage value, determine the peak value of the magnetization current to be equal to the first current value; and
if the detected value of the output voltage is larger than the second voltage value, determine the peak value of the magnetization current to be equal to the second current value.

11. A controller for a power converter, the controller comprising:
an output-voltage detector configured to detect a value of an output voltage of the power converter and generate a first detection signal that represents the detected value of the output voltage;
a peak-current-value determination unit configured to receive the first detection signal and, based on at least information associated with the detected value of the output voltage, determine a peak value of a magnetization current for the power converter, the peak-current-value determination unit being further configured to generate a peak signal that represents the determined peak value of the magnetization current;
a threshold-current-value determination unit configured to receive the peak signal, determine a threshold value for an output current of the power converter based at least in part on the peak signal, and generate a threshold signal that represents the determined threshold value; and
a mode determination unit configured to receive the threshold signal and determine a mode of operation for the power converter based on at least information associated with the determined threshold value.

12. The controller of claim 11, and further comprising an output-current detector configured to detect a value of the output current of the power converter and generate a second detection signal that represents the detected value of the output current.

13. The controller of claim 12 wherein the mode determination unit is further configured to receive the second detection signal and determine the mode of operation for the power converter based on at least information associated with the determined threshold value and the detected value of the output current.

14. The controller of claim 13 wherein the mode determination unit is further configured to, when the power converter operates in a discontinuous conduction mode, in response to the detected value of the output current becoming larger than the determined threshold value, change the mode of operation for the power converter from the discontinuous conduction mode to a critical conduction mode.

15. The controller of claim 13 wherein the mode determination unit is further configured to, when the power converter operates in a critical conduction mode, in response to the detected value of the output current becoming smaller than the determined threshold value, change the mode of operation for the power converter from the critical conduction mode to a discontinuous conduction mode.

16. The controller of claim 15 wherein, for the power converter, each period of the discontinuous conduction mode includes N consecutive cycles of critical conduction mode and an additional time duration, N being a positive integer.

17. The controller of claim 11 wherein the threshold-current-value determination unit is further configured to change the determined threshold value for the output current if the determined peak value of the magnetization current changes.

18. The controller of claim 17 wherein the threshold-current-value determination unit is further configured to:
increase the determined threshold value for the output current if the determined peak value of the magnetization current increases; and
decrease the determined threshold value for the output current if the determined peak value of the magnetization current decreases.

19. The controller of claim 17 wherein the threshold-current-value determination unit is further configured to, change the determined threshold value for the output current linearly with the changing determined peak value of the magnetization current.

20. The controller of claim 11 wherein the threshold-current-value determination unit is further configured to change the determined threshold value for the output current if the detected value of the output voltage of the power converter changes.

21. The controller of claim 20 wherein the threshold-current-value determination unit is further configured to:
increase the determined threshold value for the output current if the detected value of the output voltage of the power converter increases; and
decrease the determined threshold value for the output current if the detected value of the output voltage of the power converter decreases.

22. The controller of claim 11 wherein the threshold-current-value determination unit is further configured to, if the detected value of the output voltage is larger than or equal to a first voltage value and is smaller than or equal to a second voltage value, change the determined threshold value for the output current linearly with the changing detected value of the output voltage.

23. The controller of claim 22 wherein the threshold-current-value determination unit is further configured to, if the detected value of the output voltage is larger than or equal to the first voltage value and is smaller than or equal to the second voltage value,
increase the determined threshold value for the output current linearly with the increasing detected value of the output voltage; and
decrease the determined threshold value for the output current linearly with the decreasing detected value of the output voltage.

24. The controller of claim 22 wherein the threshold-current-value determination unit is further configured to:
if the detected value of the output voltage is equal to the first voltage value, determine the threshold value for the output current to be equal to a first current value; and
if the detected value of the output voltage is equal to the second voltage value, determine the threshold value for the output current to be equal to a second current value.

25. The controller of claim 24 wherein the threshold-current-value determination unit is further configured to:
if the detected value of the output voltage is smaller than the first voltage value, determine the threshold value for the output current to be equal to the first current value; and
if the detected value of the output voltage is larger than the second voltage value, determine the threshold value for the output current to be equal to the second current value.

26. A method for a power converter, the method comprising:
detecting a value of an output voltage of the power converter;
generating a detection signal that represents the detected value of the output voltage;
receiving the detection signal that represents the detected value of the output voltage;
determining a peak value of a magnetization current for the power converter in a discontinuous conduction mode based on at least information associated with the detected value of the output voltage of the power converter; and
generating a peak signal that represents the determined peak value of the magnetization current for the power converter in the discontinuous conduction mode;
wherein, for the power converter, each period of the discontinuous conduction mode includes N consecutive cycles of critical conduction mode and an additional time duration, N being a positive integer.

27. A method for a power converter, the method comprising:
detecting a value of an output voltage of the power converter;
generating a first detection signal that represents the detected value of the output voltage;
receiving the first detection signal that represents the detected value of the output voltage;
determining a peak value of a magnetization current for the power converter based on at least information associated with the detected value of the output voltage;
generating a peak signal that represents the determined peak value of the magnetization current;
receiving the peak signal;
determining a threshold value for an output current of the power converter based at least in part on the peak signal;
generating a threshold signal that represents the determined threshold value;
receiving the threshold signal that represents the determined threshold value; and
determining a mode of operation for the power converter based on at least information associated with the determined threshold value.
